(19) United States
(12) Patent Application Publication
(10) Pub. No.: US 2017/0265217 A1
(43) Pub. Date: Sep. 14, 2017

(54) APPARATUS, SYSTEM AND METHOD OF COMMUNICATING PILOT SIGNALS ACCORDING TO A DIVERSITY SCHEME

(71) Applicant: INTEL CORPORATION, Santa Clara, CA (US)

(72) Inventors: Artyom Lomayev, Nizhny Novgorod (RU); Alexander Maltsev, Nizhny Novgorod (RU); Michael Genossar, Modiin (IL); Carlos Cordeiro, Portland, OR (US)

(21) Appl. No.: 15/278,978

(22) Filed: Sep. 28, 2016

Related U.S. Application Data
(60) Provisional application No. 62/305,630, filed on Mar. 9, 2016.

(51) Int. Cl. H04W 72/12; H04B 7/04; H04L 5/00

(52) U.S. Cl. CPC H04W 72/1263; H04L 5/005; H04B 7/04; H04L 27/2601

(57) ABSTRACT

For example, a wireless station may be configured to map a plurality of data symbols to Orthogonal Frequency-Division Multiplexing (OFDM) symbols in a plurality of spatial streams, to may map a plurality of pilot sequences to the OFDM symbols according to a pilot mapping scheme, and to transmit a Multi-In-Multi-Out (MIMO) transmission based on the plurality of spatial streams.

### CROSS REFERENCE

This application claims the benefit of and priority from U.S. Provisional Patent Application No. 62/305,630 entitled “Apparatus, System and Method of Communicating Pilot Signals According to a Diversity Scheme”, filed Mar. 9, 2016, the entire disclosure of which is incorporated herein by reference.

### TECHNICAL FIELD

Embodiments described herein generally relate to communicating pilot signals according to a diversity scheme.

### BACKGROUND

A wireless communication network in a millimeter-wave (mmWave) band may provide high-speed data access for users of wireless communication devices.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic illustration of a space-time transmit diversity scheme, which may be implemented, in accordance with some demonstrative embodiments.

FIG. 3 is a schematic illustration of a mapping of symbols to subcarriers, in accordance with some demonstrative embodiments.

FIG. 4 is a schematic illustration of a random generator, which may be implemented to generate a value to be applied to a pilot sequence, in accordance with some demonstrative embodiments.

FIG. 5 is a schematic illustration of a pilot mapping scheme, in accordance with some demonstrative embodiments.

FIG. 6 is a schematic flow-chart illustration of a method of transmitting a transmission including pilot signals according to a transmit diversity scheme, in accordance with some demonstrative embodiments.

FIG. 7 is a schematic flow-chart illustration of a method of processing a received transmission including pilot signals according to a transmit diversity scheme, in accordance with some demonstrative embodiments.

FIG. 8 is a schematic illustration of a product of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a sensor device, an Internet of Things (IoT) device, a wearable device, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing IEEE 802.11 standards (including IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11ac-2013 (“IEEE P802.11ac-2013, IEEE Standard for Information Technology—Telecommunications and Information Exchange Between Systems—Local and Metropolitan Area Networks Specific Requirements—Part 11: Wireless LAN Medium Access Control (MAC) and Physical Layer (PHY) Specifications—Amendment 4: Enhancements for Very High Throughput for Operation in Bands below 6 GHz”, December, 2013); IEEE 802.11ad (“IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications Amendment 3: Enhancements for Very High Throughput in the 60 GHz Band”, 28 December, 2012); IEEE-802.11REVmc (“IEEE 802.11-REVmc™/D3.0, June 2014 draft standard for Information technology—Telecommunications and information exchange between systems Local and metropolitan area networks Specific requirements; Part 11: Wireless LAN Medium Access Control (MAC) and Physical Layer (PHY) Specification”); IEEE802.11-ay (P802.11ay Standard for Information Technology—Telecommunications and Information Exchange Between Systems Local and Metropolitan Area Networks—Specific Requirements Part 11: Wireless LAN Medium Access Control (MAC) and Physical Layer (PHY) Specifications—Amendment: Enhanced Throughput for Operation in License-Exempt Bands Above 45 GHz)) and/or future versions and/or derivatives thereof, devices and/or networks operating in accordance with existing WiFi Alliance (WFA) Peer-to-Peer (P2P) specifications (including WiFi P2P technical specification, version 1.5, Aug. 4, 2015) and/or future versions and/or derivatives thereof, devices and/or networks operating in accordance with existing Wireless-Gigabit-Alliance (WGA) specifications (including Wireless Gigabit Alliance, Inc WiGig MAC and PHY Specification Version 1.1, April 2011, Final specification) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, units and/or devices which are part of the above networks, and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G), or Sixth Generation (6G) mobile networks, 3GPP, Long Term Evolution (LTE), LTE advanced, Enhanced Data rates for GSM Evolution (EDGE), or the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

As used herein, the term “circuitry” may refer to, be part of, or include, an Application Specific Integrated Circuit (ASIC), an integrated circuit, an electronic circuit, a processor (shared, [symbol] edicated, or group), and/or memory (shared, dedicated, or group), that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative embodiments may be used in conjunction with a WLAN, e.g., a wireless fidelity (WiFi) network. Other embodiments may be used in conjunction with any other suitable wireless communication network, for example, a wireless area network, a “piconet”, a WPAN, a WVAN and the like.

Some demonstrative embodiments may be used in conjunction with a wireless communication network communicating over a frequency band of 60 GHz. However, other embodiments may be implemented utilizing any other suitable wireless communication frequency bands, for example, an Extremely High Frequency (EHF) band (the millimeter wave (mmWave) frequency band), e.g., a frequency band within the frequency band of between 20 Ghz and 300 GHZ, a WLAN frequency band, a WPAN frequency band, a frequency band according to the WGA specification, and the like.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

The phrase “peer to peer (PTP) communication”, as used herein, may relate to device-to-device communication over a wireless link (“peer-to-peer link”) between devices. The PTP communication may include, for example, a WiFi Direct (WFD) communication, e.g., a WFD Peer to Peer (P2P) communication, wireless communication over a direct link within a Quality of Service (QoS) basic service set (BSS), a tunneled direct-link setup (TDLS) link, a STA-to-STA communication in an independent basic service set (IBSS), or the like.

The phrases “directional multi-gigabit (DMG)” and “directional band” (DBand), as used herein, may relate to a frequency band wherein the Channel starting frequency is above 45 GHz. In one example, DMG communications may involve one or more directional links to communicate at a rate of multiple gigabits per second, for example, at least 1 Gigabit per second, e.g., at least 7 Gigabit per second, at least 30 Gigabit per second, or any other rate.

Some demonstrative embodiments may be implemented by a DMG STA (also referred to as a “millimeter-wave (mmWave) STA (mSTA)”), which may include for example, a STA having a radio transmitter, which is capable of operating on a channel that is within the DMG band. The DMG STA may perform other additional or alternative functionality. Other embodiments may be implemented by any other apparatus, device and/or station.

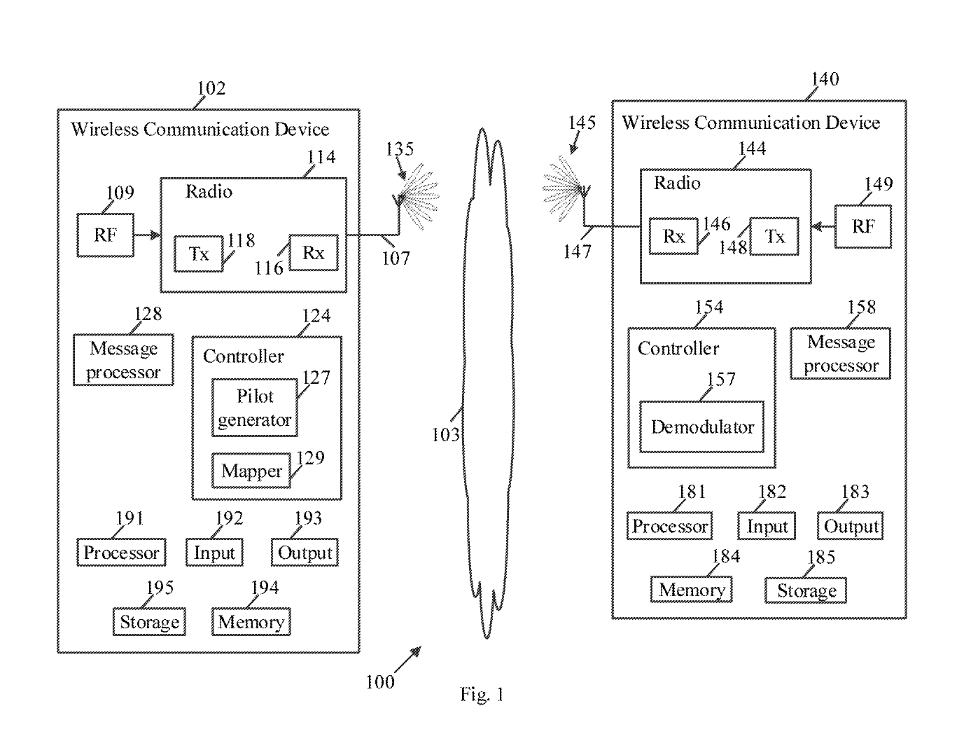

Reference is made to FIG. 1, which schematically illustrates a system 100, in accordance with some demonstrative embodiments.

As shown in FIG. 1, in some demonstrative embodiments, system 100 may include one or more wireless communication devices. For example, system 100 may include a wireless communication device 102, a wireless communication device 140, and/or one more other devices.

In some demonstrative embodiments, wireless communication devices 102 and/or 140 may include a mobile device or a non-mobile, e.g., a static, device.

For example, wireless communication devices 102 and/or 140 may include, for example, a UE, an MD, a STA, an AP, a PC, a desktop computer, a mobile computer, a laptop computer, an Ultrabook™ computer, a notebook computer, a tablet computer, a server computer, a handheld computer, a handheld device, an Internet of Things (IoT) device, a sensor device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative embodiments, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative embodiments, some or all of the components of one or more of devices 102 and/or 140 may be enclosed in a common housing or packaging, and may be interconnected or operably associated using one or more wired or wireless links. In other embodiments, components of one or more of devices 102 and/or 140 may be distributed among multiple or separate devices.

In some demonstrative embodiments, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 executes instructions, for example, of an Operating System (OS) of device 102 and/or of one or more suitable applications. Processor 181 executes instructions, for example, of an Operating System (OS) of device 140 and/or of one or more suitable applications.

In some demonstrative embodiments, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative embodiments, memory unit 194 and/or memory unit 184 may include, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 includes, for example, a hard disk drive, a floppy disk drive, a Compact Disk (CD) drive, a CD-ROM drive, a DVD drive, or other suitable removable or non-removable storage units. Memory unit 194 and/or storage unit 195, for example, may store data processed by device 102. Memory unit 184 and/or storage unit 185, for example, may store data processed by device 140.

In some demonstrative embodiments, wireless communication devices 102 and/or 140 may be capable of communicating content, data, information and/or signals via a wireless medium (WM) 103. In some demonstrative embodiments, wireless medium 103 may include, for example, a radio channel, a cellular channel, an RF channel, a Wireless Fidelity (WiFi) channel, an IR channel, a Bluetooth (BT) channel, a Global Navigation Satellite System (GNSS) Channel, and the like.

In some demonstrative embodiments, WM 103 may include a directional channel in a directional frequency band. For example, WM 103 may include a millimeter-wave (mmWave) wireless communication channel.

In some demonstrative embodiments, WM 103 may include a DMG channel. In other embodiments, WM 103 may include any other additional or alternative directional channel.

In other embodiments, WM 103 may include any other type of channel over any other frequency band.

In some demonstrative embodiments, devices 102 and/or 140 may perform the functionality of one or more wireless stations (STA), e.g., as described below.

In some demonstrative embodiments, devices 102 and/or 140 may perform the functionality of one or more DMG stations.

In other embodiments, devices 102 and/or 140 may perform the functionality of any other wireless device and/or station, e.g., a WLAN STA, a WiFi STA, and the like.

In some demonstrative embodiments, devices 102 and/or 140 may be configured to perform the functionality of an access point (AP), e.g., a DMG AP, and/or a personal basic service set (PBSS) control point (PCP), e.g., a DMG PCP, for example, an AP/PCP STA, e.g., a DMG AP/PCP STA.

In some demonstrative embodiments, devices 102 and/or 140 may be configured to perform the functionality of a non-AP STA, e.g., a DMG non-AP STA, and/or a non-PCP STA, e.g., a DMG non-PCP STA, for example, a non-AP/PCP STA, e.g., a DMG non-AP/PCP STA.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains a station (STA), e.g., one STA, and provides access to distribution services, via the wireless medium (WM) for associated STAs. The AP may perform any other additional or alternative functionality.

In one example, a personal basic service set (PBSS) control point (PCP) may include an entity that contains a STA, e.g., one station (STA), and coordinates access to the wireless medium (WM) by STAs that are members of a PBSS. The PCP may perform any other additional or alternative functionality.

In one example, a PBSS may include a directional multi-gigabit (DMG) basic service set (BSS) that includes, for example, one PBSS control point (PCP). For example, access to a distribution system (DS) may not be present, but, for example, an intra-PBSS forwarding service may optionally be present.

In one example, a PCP/AP STA may include a station (STA) that is at least one of a PCP or an AP. The PCP/AP STA may perform any other additional or alternative functionality.

In one example, a non-AP STA may include a STA that is not contained within an AP. The non-AP STA may perform any other additional or alternative functionality.

In one example, a non-PCP STA may include a STA that is not a PCP. The non-PCP STA may perform any other additional or alternative functionality.

In one example, a non PCP/AP STA may include a STA that is not a PCP and that is not an AP. The non-PCP/AP STA may perform any other additional or alternative functionality.

In some demonstrative embodiments, devices 102 and/or 140 may include one or more radios including circuitry and/or logic to perform wireless communication between devices 102, 140 and/or one or more other wireless communication devices. For example, device 102 may include a radio 114, and/or device 140 may include a radio 144.

In some demonstrative embodiments, radio 114 and/or 144 may include one or more wireless receivers (Rx) including circuitry and/or logic to receive wireless communication signals, RF signals, frames, blocks, transmission streams, packets, messages, data items, and/or data. For example, radio 114 may include at least one receiver 116, and/or radio 144 may include at least one receiver 146.

In some demonstrative embodiments, radios 114 and/or 144 may include one or more wireless transmitters (Tx) including circuitry and/or logic to transmit wireless communication signals, RF signals, frames, blocks, transmission streams, packets, messages, data items, and/or data. For example, radio 114 may include at least one transmitter 118, and/or radio 144 may include at least one transmitter 148.

In some demonstrative embodiments, radio 114 and/or radio 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radio 114 and/or radio 144 may include or may be implemented as part of a wireless Network Interface Card (NIC), and the like.

In some demonstrative embodiments, radios 114 and/or 144 may be configured to communicate over a directional band, for example, an mmWave band, and/or any other band, for example, a 2.4 GHz band, a 5 GHz band, a S1G band, and/or any other band.

In some demonstrative embodiments, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140 and/or one or more other devices, e.g., as described below.

In some demonstrative embodiments, controllers 124 and/or 154 may include circuitry and/or logic, e.g., one or more processors including circuitry and/or logic, memory circuitry and/or logic, Media-Access Control (MAC) circuitry and/or logic, Physical Layer (PHY) circuitry and/or logic, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein.

In some demonstrative embodiments, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In some demonstrative embodiments, device 140 may include a message processor 158 configured to generate, process and/or access one or messages communicated by device 140.

In one example, message processor 158 may be configured to generate one or more messages to be transmitted by device 140, and/or message processor 158 may be configured to access and/or to process one or more messages received by device 140, e.g., as described below.

In some demonstrative embodiments, message processors 128 and/or 158 may include circuitry and/or logic, e.g., one or more processors including circuitry and/or logic, memory circuitry and/or logic, Media-Access Control (MAC) circuitry and/or logic, Physical Layer (PHY) circuitry and/or logic, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative embodiments, at least part of the functionality of message processor 128 may be implemented as part of radio 114, and/or at least part of the functionality of message processor 158 may be implemented as part of radio 144.

In some demonstrative embodiments, at least part of the functionality of message processor 128 may be implemented as part of controller 124, and/or at least part of the functionality of message processor 158 may be implemented as part of controller 154.

In other embodiments, the functionality of message processor 128 may be implemented as part of any other element of device 102, and/or the functionality of message processor 158 may be implemented as part of any other element of device 140.

In some demonstrative embodiments, at least part of the functionality of controller 124 and/or message processor 128 may be implemented by an integrated circuit, for example, a chip, e.g., a System on Chip (SoC). In one example, the chip or SoC may be configured to perform one or more functionalities of radio 114. For example, the chip or SoC may include one or more elements of controller 124, one or more elements of message processor 128, and/or one or more elements of radio 114. In one example, controller 124, message processor 128, and radio 114 may be implemented as part of the chip or SoC.

In other embodiments, controller 124, message processor 128 and/or radio 114 may be implemented by one or more additional or alternative elements of device 102.

In some demonstrative embodiments, at least part of the functionality of controller 154 and/or message processor 158 may be implemented by an integrated circuit, for example, a chip, e.g., a System on Chip (SoC). In one example, the chip or SoC may be configured to perform one or more functionalities of radio 144. For example, the chip or SoC may include one or more elements of controller 154, one or more elements of message processor 158, and/or one or more elements of radio 144. In one example, controller 154, message processor 158, and radio 144 may be implemented as part of the chip or SoC.

In other embodiments, controller 154, message processor 158 and/or radio 144 may be implemented by one or more additional or alternative elements of device 140.

In some demonstrative embodiments, radios 114 and/or 144 may include, or may be associated with, a plurality of directional antennas.

In some demonstrative embodiments, device 102 may include one or more, e.g., a plurality of, directional antennas 107, and/or device 140 may include on or more, e.g., a plurality of, directional antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. Antennas 107 and/or 147 may include, for example, antennas suitable for directional communication, e.g., using beamforming techniques. For example, antennas 107 and/or 147 may include a phased array antenna, a multiple element antenna, a set of switched beam antennas, and/or the like. In some embodiments, antennas 107 and/or 147 may implement transmit and receive functionalities using separate transmit and receive antenna elements. In some embodiments, antennas 107 and/or 147 may implement transmit and receive functionalities using common and/or integrated transmit/receive elements.

In some demonstrative embodiments, antennas 107 and/or 147 may include directional antennas, which may be steered to one or more beam directions. For example, antennas 107 may be steered to one or more beam directions 135, and/or antennas 147 may be steered to one or more beam directions 145.

In some demonstrative embodiments, antennas 107 and/or 147 may include and/or may be implemented as part of a single Phased Antenna Array (PAA).

In some demonstrative embodiments, antennas 107 and/or 147 may be implemented as part of a plurality of PAAs, for example, as a plurality of physically independent PAAs.

In some demonstrative embodiments, a PAA may include, for example, a rectangular geometry, e.g., including an integer number, denoted M, of rows, and an integer number, denoted N, of columns. In other embodiments, any other types of antennas and/or antenna arrays may be used.

In some demonstrative embodiments, antennas 107 and/or antennas 147 may be connected to, and/or associated with, one or more Radio Frequency (RF) chains.

In some demonstrative embodiments, device 102 may include one or more, e.g., a plurality of, RF chains 109 connected to, and/or associated with, antennas 107.

In some demonstrative embodiments, device 140 may include one or more, e.g., a plurality of, RF chains 149 connected to, and/or associated with, antennas 147.

In some demonstrative embodiments devices 102 and/or 140 may be configured to communicate over a Next Generation 60 GHz (NG60) network, an Extended DMG (EDMG) network, and/or any other network. For example, devices 102 and/or 140 may perform Multi-In-Multi-Out (MIMO) communication, for example, for communicating over the NG60 and/or EDMG networks, e.g., over an NG60 or an EDMG frequency band.

Some demonstrative embodiments may be implemented, for example, as part of a new standard in an mmWave band, e.g., a 60 GHz frequency band or any other directional band, for example, as an evolution of an IEEE 802.11ad standard.

In some demonstrative embodiments, devices 102 and/or 140 may be configured according to one or more standards, for example, in accordance with an IEEE 802.11ay Standard, which may be, for example, configured to enhance the efficiency and/or performance of an IEEE 802.11ad Specification, which may be configured to provide WiFi connectivity in a 60 GHz band.

Some demonstrative embodiments may enable, for example, to significantly increase the data transmission rates defined in the IEEE 802.11ad specification, for example, from 7 Gbps, e.g., up to 30 Gbps, or to any other data rate, which may, for example, satisfy growing demand in network capacity for new coming applications.

Some demonstrative embodiments may be implemented, for example, to allow increasing a transmission data rate, for example, by applying Multiple Input Multiple Output (MIMO) and/or channel bonding techniques.

Some wireless communication Specifications, for example, the IEEE 802.11ad-2012 Specification, may be configured to support a Single User (SU) system, in which a Station (STA) may transmit frames to a single STA at a time.

Some demonstrative embodiments may enable, for example, communication in one or more use cases, which may include, for example, a wide variety of indoor and/or outdoor applications, including but not limited to, for example, at least, high speed wireless docking, ultra-short range communications, 8K Ultra High Definition (UHD) wireless transfer at smart home, augmented reality headsets and high-end wearables, data center inter-rack connectivity, mass-data distribution or video on demand system, mobile offloading and multi-band operation, mobile front-hauling, and/or wireless backhaul.

In some demonstrative embodiments, a communication scheme may include Physical layer (PHY) and/or Media Access Control (MAC) layer schemes, for example, to support one or more applications, and/or increased transmission data rates, e.g., data rates of up to 30 Gbps, or any other data rate.

In some demonstrative embodiments, the PHY and/or MAC layer schemes may be configured to support frequency channel bonding over a mmWave band, e.g., over a 60 GHz band, Single User (SU) techniques, and/or Multi User (MU) MIMO techniques.

In some demonstrative embodiments, devices 102 and/or 140 may be configured to implement one or more mechanisms, which may be configured to enable SU and/or MU communication of Downlink (DL) and/or Uplink frames (UL) using a MIMO scheme.

In some demonstrative embodiments, devices 102 and/or 140 may be configured to communicate MIMO communications over the mmWave wireless communication band.

In some demonstrative embodiments, devices 102 and/or 140 may be configured to communicate over an NG60 network, an EDMG network, and/or any other network and/or any other frequency band. For example, devices 102 and/or 140 may be configured to communicate DL MIMO transmissions and/or UL MIMO transmissions, for example, for communicating over the NG60 and/or EDMG networks.

In some demonstrative embodiments, devices 102 and/or 140 may be configured to implement one or more techniques, which may, for example, enable to support communications over a MIMO communication channel, e.g., a SU-MIMO channel between two mmWave STAs, or a MU-MIMO channel between a STA and a plurality of STAs.

In some demonstrative embodiments, devices 102 and/or 140 may be configured to communicate according to a diversity scheme for MIMO transmission, e.g., as described below.

In some demonstrative embodiments, the diversity scheme may be configured, for example, based on a space-time diversity scheme, e.g., as described below.

In some demonstrative embodiments, devices 102 and/or 140 may be configured to communicate according to a space-time diversity scheme, which may be configured, for example, for OFDM MIMO, e.g., as described below.

In other embodiments, the MIMO diversity scheme may support any other additional or alternative diversity technique.

In some demonstrative embodiments, the transmit diversity scheme may be implemented for example, for communication in accordance with an IEEE 802.11ay Specification, and/or any other standard, protocol and/or specification.

In some demonstrative embodiments, devices 102 and/or 140 may be configured to communicate according to a transmit diversity scheme, which may be configured, for example, for 2×N MIMO communication, e.g., as described below. In other embodiments, a space-frequency transmit diversity scheme may be configured, for example, for any other type of MIMO communication, e.g., any other M×N MIMO communication, e.g., wherein N is equal or greater than 2, and M is equal or greater than 2.

In some demonstrative embodiments, the space-time diversity scheme may be configured, for example, in compliance with one or more aspects of an Alamouti technique, for example, as described by Siavash M Alamouti, “A Simple Transmit Diversity Technique for Wireless Communications,” IEEE Journal on Selected Areas in Communications, vol. 16, no. 8, October 1998.

In one example, the transmit space-time diversity scheme may be configured to support, for example, transmission from 2 Transmit (TX) antennas to N Receive (RX) antennas, for example, for communication according to a 2×NMIMO scheme.

In other embodiments, the diversity scheme may be configured, for example, based on any other space-time diversity scheme, for example, a Space Time Block Code (STBC) scheme, and/or any other diversity scheme.

In some demonstrative embodiments, a first device (“transmitter device” or “transmitter side”), e.g., device 102, may be configured to generate and transmit a MIMO transmission based on a plurality of spatial streams, for example, in accordance with a transmit space-time diversity scheme, e.g., as described below.

In some demonstrative embodiments, a second device (“receiver device” or “receiver side”), e.g., device 140, may be configured to receive and process the MIMO transmission based on the plurality of spatial streams, for example, in accordance with the transmit space-time diversity scheme, e.g., as described below.

In some demonstrative embodiments, one or more aspects of the transmit space-time diversity scheme described herein may be implemented, for example, to provide at least a technical solution to allow a simple combining scheme at the receiver device, for example, to mitigate and/or cancel out interference, e.g., Inter Stream Interference (ISI), to combine channel diversity gain, which may provide reliable data transmission, e.g., even in hostile channel conditions, and/or to provide one or more additional and/or alternative advantages and/or technical solutions.

For example, in some embodiments, the receiver side may not even be required to use a MIMO equalizer, for example, while being able to use at least only Single Input Single Output (SISO) equalizers, e.g., in each stream of the plurality of spatial streams. According to this example, the diversity MIMO scheme may be simple for implementation.

In some demonstrative embodiments, a PHY and/or Media Access Control (MAC) layer for a system operating in the 60 GHz band, e.g., the system of FIG. 1, may be defined, for example, in accordance with an IEEE 802.11ad Standard, a future IEEE 802.11ay Standard, and/or any other Standard.

In some demonstrative embodiments, some implementations may be configured to communicate a MIMO transmission over a directional channel, for example, using beamforming with a quite narrow beamwidth and fast enough signal transmission with typical frame duration, e.g., of about 100 microseconds (usec). Such implementations may allow, for example, having a static channel per entire packet transmission, and/or may enable the receiver side to perform channel estimation at the very beginning of the packet, e.g., using a Channel Estimation Field (CEF). A phase may be tracked, for example, instead of performing channel tracking using pilots. This may allow, for example, assuming a substantially unchanged or static channel over two or more successive symbol transmissions.

In some demonstrative embodiments, devices 102 and/or 140 may be configured to communicate a MIMO transmission according to a transmit diversity scheme, which may be based on a space-time diversity scheme, for example, a Space Time Block Code (STBC) scheme, e.g., an Alamouti diversity scheme, or any other space-time diversity scheme, e.g., as described below.

For example, a space-time diversity scheme, e.g., in accordance with the Alamouti diversity scheme, may be configured to transmit a pair of signals, denoted (S₀, S₁), for example, concurrently via two antennas, denoted #0 and #1, at a time moment, denoted t; followed by repetition of the signals with coding, e.g., the signals (−S₁*, S₀*), via the antennas #0 and #1, at a subsequent time moment, denoted t+T. The symbol * denotes an operation of complex conjugation. This diversity scheme may create two orthogonal sequences in a space-time domain.

In some demonstrative embodiments, it may be assumed that the channel does not change during consequent vector transmissions, for example, for communications over a narrow beamwidth, e.g., over a directional frequency band, as described above. Accordingly, it may be assumed that the sequential transmissions of the signals S₀ and −S₁* are transmitted through a substantially unchanged or static channel having a substantially unchanged or static channel coefficient H₀, and/or that the sequential transmissions of the signals S₁ and S₀* are transmitted through a substantially unchanged or static channel having a substantially unchanged or static channel coefficient H₁.

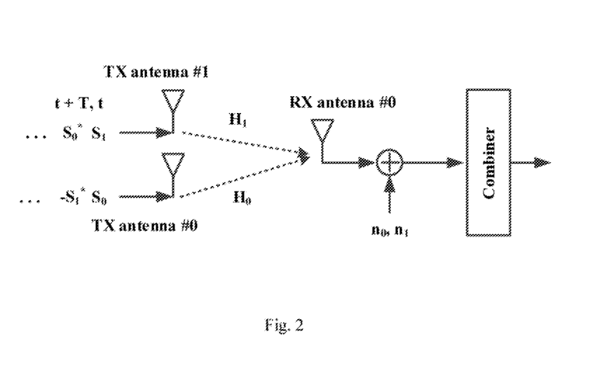

FIG. 2 is a schematic illustration of a transmit diversity scheme, which may be implemented, in accordance with some demonstrative embodiments. For example, the transmit diversity scheme of FIG. 2 illustrates spatial coding in accordance with an Alamouti transmit diversity scheme with a 2×1 configuration.

Referring back to FIG. 1, in some demonstrative embodiments, devices 102 and/or 140 may be configured to communicate according to a space-time transmit diversity scheme, which may be configured, for example, for 2×1 MIMO communication, e.g., as shown in FIG. 2.

In other embodiments, devices 102 and/or 140 may be configured to communicate according to a space-time transmit diversity scheme, which may be configured, for example, for any other type of MIMO communication, e.g., any other M_{T}×N_{R} MIMO communication, e.g., wherein M_{T} is equal or greater than 2, and N_{R} is equal or greater than 1.

In some demonstrative embodiments, a diversity scheme, which may be configured, for example, for OFDM modulation, may be applied, for example, in a frequency domain, for example, by repetition mapping to subcarriers, e.g., as described below.

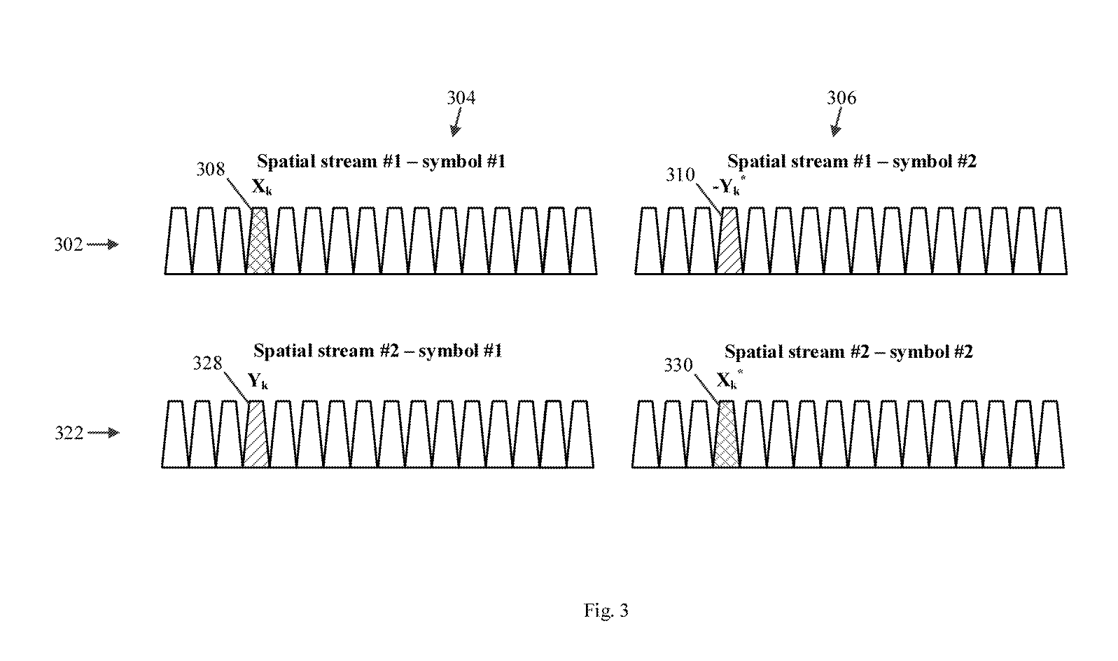

Reference is made to FIG. 3, which schematically illustrates a mapping scheme 300 to map symbols to subcarriers, in accordance with some demonstrative embodiments. For example, devices 102 and/or 140 (FIG. 1) may be configured to communicate a MIMO transmission according to the mapping scheme of FIG. 3.

In some demonstrative embodiments, the mapping of symbols to subcarriers shown in FIG. 3 may be configured to support a diversity scheme, for example, according to a time-space diversity scheme, for example in accordance with the Alamouti diversity technique, e.g., as described above with reference to FIG. 2.

In some demonstrative embodiments, as shown in FIG. 3, a plurality of data symbols may be mapped to a first frequency-domain spatial stream 302 and a first frequency-domain spatial stream 304.

In some demonstrative embodiments, as shown in FIG. 3, a pair of symbols, denoted (Xₖ, Yₖ), may be mapped to a subcarrier with an index k of an OFDM symbol 304, denoted symbol#1, in the spatial streams 302 and 322, denoted stream#1 and stream#2, respectively.

In some demonstrative embodiments, as shown in FIG. 3, a repetition of the pair of symbols (Xₖ, Yₖ) with coding, e.g., a pair of encoded symbols (−Yₖ*, Xₖ*), may be mapped to a subsequent OFDM symbol 306, denoted Symbol#2, for example, to the same subcarrier with the index k in the spatial streams 302 and 322.

For example, as shown in FIG. 3, the first frequency-domain spatial stream 302 may include a first data symbol of a first data sequence, e.g., the data symbol Xₖ, mapped to a subcarrier 308 of the first frequency symbol 304, and the second frequency-domain spatial stream 322 may include a second data symbol of a second data sequence, e.g., the data symbol Yₖ, mapped to a subcarrier 328, e.g., the same k-th subcarrier 308, of the first frequency symbol 304.

For example, as shown in FIG. 3, the first frequency-domain spatial stream 302 may include a sign-inverted complex conjugate of the second data symbol, e.g., Yₖ*, mapped to a subcarrier 310 of the second frequency symbol 306, and the second frequency-domain spatial stream 322 may include a complex conjugate of the first data symbol, e.g., Xₖ*, mapped to a subcarrier 330, e.g., the same subcarrier 310, of the second frequency symbol 306.

In some demonstrative embodiments, the diversity scheme of FIG. 3 may be applied for an OFDM modulation, for example, in a frequency domain, for example, by repetition mapping to the subcarriers in streams 302 and 322.

In some demonstrative embodiments, it may be assumed that the channel per subcarrier does not change, for example, for a transmission over a directional frequency band, for example, due to the stationary property of the channel in the 60 GHz band. Accordingly, an optimal combining technique, e.g., in accordance with space-time combining technique, may be applied at the receiver side, for example, to create diversity gain and/or cancel out inter stream interference, e.g., as described below.

In some demonstrative embodiments, a space-time diversity scheme, for example, the Alamouti scheme, may be applied to the OFDM PHY transmission, for example, when performing data mapping in the frequency domain. However, in contrast to the OFDM mapping performed in the frequency domain, other types of mapping, for example, a Single Carrier (SC) PHY mapping of symbols, may be performed in the time domain.

Referring back to FIG. 1, in some demonstrative embodiments a wireless device, e.g., devices 102 and/or 140, may be configured to communicate according to a space-time transmit diversity scheme, which may define a mapping of subcarriers to a plurality of spatial streams, e.g., to two spatial streams or any other number of spatial streams, for example, for OFDM MIMO.

In some demonstrative embodiments, devices 102 and/or 140 may be configured to utilize a pilot mapping scheme, which may be configured according to the space time diversity scheme, e.g., as described below.

In some demonstrative embodiments, devices 102 and/or 140 may be configured to communicate according to a pilot structure, which may be configured for OFDM MIMO transmission with a space-time scheme, e.g., an Alamouti scheme and/or any other space-time diversity scheme.

In some demonstrative embodiments, devices 102 and/or 140 may be configured to utilize a mapping scheme including a structure of 16 pilots per OFDM symbol, e.g., as described below. In other embodiments, devices 102 and/or 140 may be configured to utilize a mapping scheme including a structure of any other number of pilots per OFDM symbol.

In some demonstrative embodiments, devices 102 and/or 140 may be configured to utilize a mapping scheme including a pilot structure of 16 pilots per OFDM symbol, which may be, for example, spanned equidistantly in the frequency domain over the entire signal bandwidth, e.g., as described below.

In some demonstrative embodiments, the pilot structure may be utilized, for example, in a future standard, for example, an IEEE 802.11ay Standard and/or any other standard.

In some demonstrative embodiments, a pilot structure, for example, which may be configured in compliance with a legacy pilot structure, e.g., of an IEEE 802.11ad Standard, may be reused, e.g., combined with, a space-time signal structure, for example, in accordance with an Alamouti technique or any other space-time diversity scheme, which may be configured, for example, at least to allow to combine signals, to cancel out inter stream interference, and/or to combine channel gain.

In some demonstrative embodiments, devices 102 and/or 140 may be configured to communicate according to a pilot structure, which may be configured, for example, to allow applying a space-time diversity scheme, e.g., an Alamouti demodulation approach, to cancel out inter stream interference, and/or to combine a diversity gain from a channel existing between M Transmit (Tx) antennas, e.g., 2 Tx antennas, and N Receive (Rx) antennas.

In some demonstrative embodiments, devices 102 and/or 140 may be configured to communicate according to a pilot structure, which may be configured, for example, in accordance with on an OFDM pilot structure, e.g., as described below. In other embodiments, the pilot structure may be configured based, on, in accordance with, and/or in compliance with, any other additional or alternative symbol and/or pilot structure, configuration and/or scheme.

In some demonstrative embodiments, devices 102 and/or 140 may be configured to utilize a pilot structure in compliance with a pilot signals structure for OFDM Single Input Single Output (SISO) transmission, e.g., in accordance with an IEEE 802.11ad Specification, e.g., as described below.

In some demonstrative embodiments, the pilot structure may define a Discrete Fourier Transform (DFT) size of 512 points (subcarriers), e.g., including 336 data subcarriers, 3 zero Direct Current (DC) subcarriers, and 16 pilot subcarriers. The DFT size may also include two guard bands of size 79, and 78 zero subcarriers. In other embodiments, any other DFT size, any other number of data subcarriers, any other number of pilot subcarriers, any other number of guard bands, and/or any other size of guard bands may be used.

In some demonstrative embodiments, the pilot subcarriers may have the indexes [+/−10, +/−30, +/−50, +/−70, +/−90, +/−110, +/−130, +/−150], and/or any other indexes. According to this example, the distance between two adjacent pilots, e.g., between every pair of adjacent pilots, may be equal to 20 subcarriers. In other embodiments any other constant or varying spacing may be applied to the pilots.

In some demonstrative embodiments, the 16 pilots may be defined as Binary Phase-Shift Keying (BPSK) modulated symbols, for example, as P=[−1, 1, −1, 1, 1, −1, −1, −1, −1, −1, 1, 1, 1, −1, 1, 1], and/or as any other sequence.

In some demonstrative embodiments, for an OFDM symbol with an index n (in time), a pilot sequence P (also referred to as “the original pilot sequence”) may be multiplied by a value 2×pₙ−1, wherein pₙ denotes a value generated by a shift register of a random generator (scrambler).

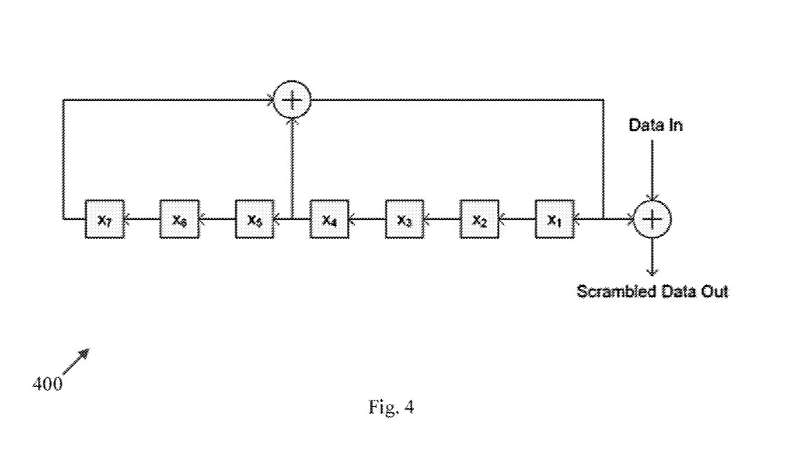

Reference is made to FIG. 4, which schematically illustrates a random generator (scrambler) 400, which may be implemented to generate a value to be applied to a pilot sequence, in accordance with some demonstrative embodiments.

In some demonstrative embodiments, as shown in FIG. 4, random generator 400 may be configured to generate a periodic sequence, e.g., of length 127 or any other length, for example, based on the polynomial x⁷+x⁴+1, for example, based on a plurality of bit values, denoted x1, x2, . . . , x7.

In some demonstrative embodiments, the plurality of bit values x1, x2, . . . , x7 may all be set to a value of “1”, e.g., at a first OFDM symbol.

In some demonstrative embodiments, the pilot sequence may change the sign to inverse one, for example, if the value of 2×pₙ−1 is equal to (−1).

Referring back to FIG. 1, in some demonstrative embodiments, devices 102 and/or 140 may be configured to utilize an OFDM pilot structure, which may be configured to support a MIMO transmission, e.g., according to a 2×N MIMO scheme, with a space-time scheme, e.g., an Alamouti scheme, exploiting 2 transmit antennas and N receive antennas, e.g., as described below.

In some demonstrative embodiments, the OFDM pilot structure may be configured to support spatial signal processing at a receiver side, e.g., as described below.

In some demonstrative embodiments, devices 102 and/or 140 may be configured to communicate a MIMO transmission, e.g., according to the diversity scheme described above with reference to FIGS. 2 and/or 3, for example, using a pilot structure, which may be configured, for example, for OFDM MIMO with a space-time diversity scheme, e.g., as described below.

In some demonstrative embodiments, controller 124 may be configured to cause, trigger, and/or control a wireless station, e.g., a DMG STA or an EDMG STA, implemented by device 102 to generate and transmit a MIMO transmission to at least one other station, for example, a station implemented by device 140, e.g., as described below.

In some demonstrative embodiments, controller 124 may include, operate as, and/or perform the functionality of a mapper 129, which may be configured to map the plurality of data blocks to a plurality of spatial streams, for example, according to a space-time diversity mapping scheme, e.g., as described below.

In some demonstrative embodiments, mapper 129 may be configured to map a plurality of data symbols to OFDM symbols in a plurality of spatial streams.

In some demonstrative embodiments, mapper 129 may be configured to map the data symbols to the OFDM symbols according to a space-time diversity mapping scheme, for example, an Alamouti-based diversity scheme and/or any other space-time diversity scheme, for example, as described above with reference to FIGS. 2 and/or 3, and/or according to any other space-time diversity scheme.

In some demonstrative embodiments, mapper 129 may be configured to map a plurality of pilot sequences to the OFDM symbols according to a pilot mapping scheme, which may be configured, for example, to support the space-time diversity scheme, e.g., as described below.

In some demonstrative embodiments, the pilot mapping scheme may be configured to map a pair of pilot sequences to a pair of OFDM symbols in the first and second spatial streams, for example, with repetition coding, e.g., as described below.

In some demonstrative embodiments, the pilot mapping scheme may include a first pilot sequence having a first index mapped to a plurality of subcarriers in a first OFDM symbol of a first spatial stream, and a second pilot sequence having a second index, subsequent to the first index, mapped to a plurality of subcarriers in a first OFDM symbol of a second spatial stream, e.g., as described below.

In some demonstrative embodiments, the pilot mapping scheme may include a repetition of the second pilot sequence with sign inversion mapped to a plurality of subcarriers in a second OFDM symbol of the first spatial stream, and a repetition of the first pilot sequence mapped to a plurality of subcarriers in a second OFDM symbol of the second spatial stream, e.g., as described below.

In some demonstrative embodiments, one or more additional pairs of pilot sequences mapped to one or more respective pairs of OFDM symbols in the first and second spatial streams, e.g., as described below.

In some demonstrative embodiments, the pilot mapping scheme may include a third pilot sequence having a third index, subsequent to the second index, mapped to a plurality of subcarriers in a third OFDM symbol of the first spatial stream, and a fourth pilot sequence having a fourth index, subsequent to the third index, mapped to a plurality of subcarriers in a third OFDM symbol of the second spatial stream, e.g., as described below.

In some demonstrative embodiments, the pilot mapping scheme may include a repetition of the fourth pilot sequence with sign inversion mapped to a plurality of subcarriers in a fourth OFDM symbol of the first spatial stream, and a repetition of the third pilot sequence mapped to a plurality of subcarriers in a fourth OFDM symbol of the second spatial stream, e.g., as described below.

In some demonstrative embodiments, controller 124 may include, operate as, and/or perform the functionality of a pilot sequence generator 127, which may be configured to generate the plurality of pilot sequences to be mapped by mapper 129, e.g., as described below. For example, pilot sequence generator 127 may be configured to generate the plurality of pilot sequences utilizing a random generator (scrambler), for example, random generator 400 (FIG. 4), e.g., as described above.

In some demonstrative embodiments, pilot sequence generator 127 may be configured to generate a pilot sequence, e.g., the first, second, third and/or fourth pilot sequence, including sixteen pilot subcarriers.

In some demonstrative embodiments, pilot sequence generator 127 may be configured to generate the pilot sequence including sixteen evenly spaced pilot subcarriers. In other embodiments, pilot sequence generator 127 may be configured to generate at least one pilot sequence having pilot subcarriers, which are not evenly spaced.

In some demonstrative embodiments, pilot sequence generator 127 may be configured to generate the pilot sequence, for example, such two adjacent pilot subcarriers of the pilot sequence, e.g., each pair of adjacent sub-carriers, are 20 subcarriers apart. In other embodiments, the pilot sequence may include pilot sub-carriers spaced by any other constant or varying number of subcarriers.

In some demonstrative embodiments, pilot sequence generator 127 may be configured to generate the pilot sequence including sixteen subcarriers with subcarrier indexes of [−150, −130, −110, −90, −70, −50, −30, −10, 10, 30, 50, 70, 90, 110, 130, 150]. In other embodiments, the pilot sequence may include any other combination of subcarriers.

In some demonstrative embodiments, pilot sequence generator 127 may be configured to generate a pilot sequence having an index n, for example, by applying to a predefined pilot sequence, denoted P, a function, which is based on a value of n.

For example, the predefined pilot sequence may include the sequence P=[−1, 1, −1, 1, 1, −1, −1, −1, −1, −1, 1, 1, 1, −1, 1, 1], or any other sequence.

In some demonstrative embodiments, pilot sequence generator 127 may be configured to generate the pilot sequence having the index n by multiplying the pilot sequence P by the value 2×pₙ−1.

For example, a pilot sequence having an index n, which may be applied to an OFDM symbol with the index n, may be generated, for example, by multiplying the pilot sequence P by the value of 2×pₙ−1. For example, the value of pₙ may be determined by the random generator 400 (FIG. 4), e.g., as described above.

In some demonstrative embodiments, controller 124 may be configured to cause, trigger, and/or control the wireless station implemented by device 102 to transmit a MIMO transmission based on the plurality of spatial streams.

In some demonstrative embodiments, controller 124 may be configured to cause, trigger, and/or control the wireless station implemented by device 102 to transmit the plurality of spatial streams via a plurality of directional antennas. For example, controller 124 may be configured to cause, trigger, and/or control the wireless station implemented by device 102 to transmit the first spatial stream via a first antenna of antennas 107, and to transmit the second spatial stream via a second antenna of antennas 107.

In some demonstrative embodiments, the MIMO transmission may include a 2×N MIMO transmission, e.g., as described below. In other embodiments, the MIMO transmission may include any other M×NMIMO transmission.

In some demonstrative embodiments, controller 124 may be configured to cause, trigger, and/or control the wireless station implemented by device 102 to transmit the MIMO transmission over a directional frequency band, for example, a DMG band.

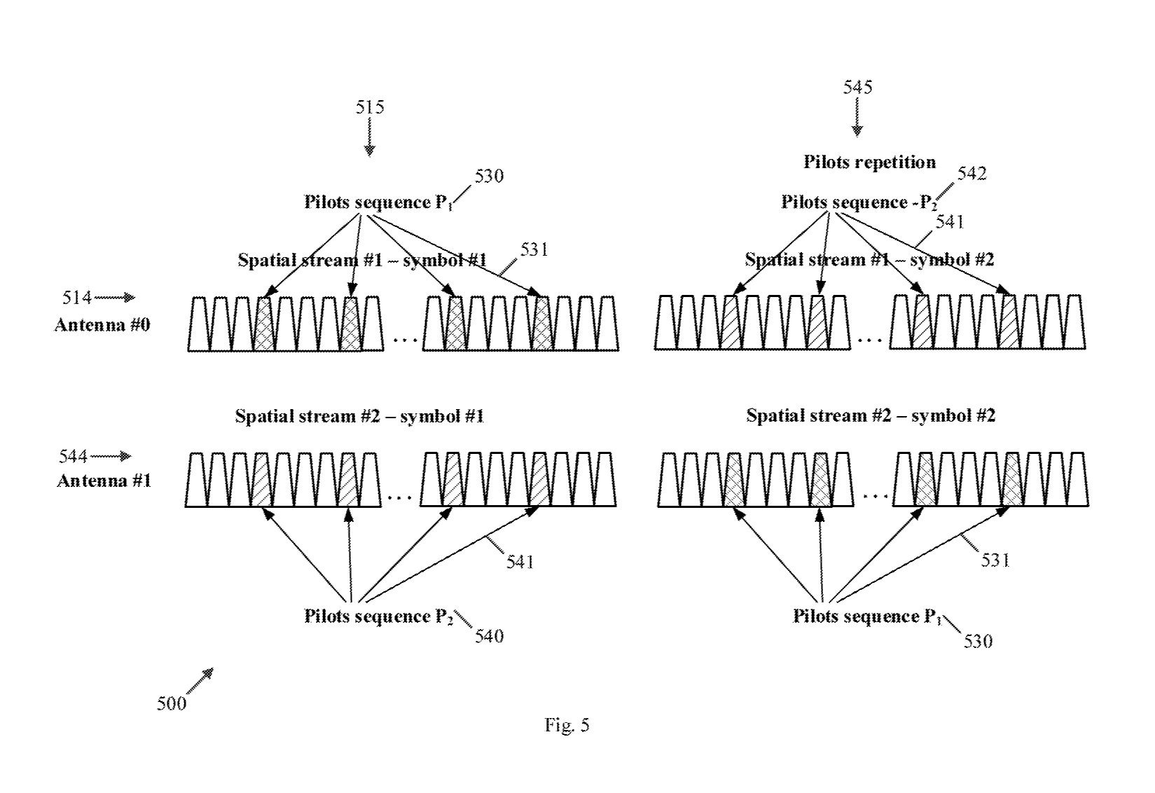

Reference is made to FIG. 5, which schematically illustrates pilot mapping scheme 500, in accordance with some demonstrative embodiments. For example, a wireless station, e.g., a wireless station implemented by device 102 (FIG. 1), may be configured to map pilot sequences to OFDM symbols of a plurality of spatial streams according to pilot mapping scheme 500, e.g., as described below. In one example, controller 124 (FIG. 1), pilot sequence generator 127 (FIG. 1) and/or mapper 129 (FIG. 1), may be configured to cause, trigger, and/or control the wireless station implemented by device 102 (FIG. 1) to map pilot sequences to be transmitted in a MIMO transmission according to pilot mapping scheme 500.

In some demonstrative embodiments, pilot mapping scheme 500 may utilize a pilot signal structure in a frequency domain, which may be configured to support pilot mapping for a 2×N MIMO transmission, e.g., to support an implementation in accordance with an IEEE 802.11ay Specification.

In some demonstrative embodiments, pilot scheme 500 may be configured to map first and second pilot sequences to subcarriers of a first OFDM symbol 515 and a second OFDM symbol 545 in a first spatial stream 514 and a second spatial stream 544, e.g., as described below.

In one example, spatial stream 514 may include OFDM symbols of stream 302 (FIG. 3), and/or spatial stream 544 may include OFDM symbols of stream 322 (FIG. 3). For example, OFDM symbol 515 may include OFDM symbol 304 (FIG. 3), and/or OFDM symbol 545 may include symbol 306 (FIG. 3).

In some demonstrative embodiments, as shown in FIG. 5, a first pilot sequence 530, denoted P1, having a first index, e.g., n=1, and a second pilot sequence 540, denoted P2, having a second index, e.g., n=2, subsequent to the first index, may be mapped to subcarriers of the OFDM symbols 515 and 545 of the spatial streams 514 and 544, e.g., as described below.

In some demonstrative embodiments, the pilot sequences 530 and/or 540 may be generated, for example, by pilot sequence generator 127 (FIG. 1), e.g., as described above.

In some demonstrative embodiments, as shown in FIG. 5, the pilot sequences P1 and P2 may be mapped to the same subcarrier indexes, e.g., as described below.

In some demonstrative embodiments, as shown in FIG. 5, the pilot sequences P1 and P2 may be mapped to the different spatial streams 514 and 544, for example, in contrast to a legacy pilot signal mapping, e.g., in accordance with an IEEE 802.11ad Specification.

In some demonstrative embodiments, as shown in FIG. 5, the pilot sequences P1 and P2 may be mapped to a same OFDM symbol in time, e.g., the OFDM symbol 515, and to different spatial streams, e.g., the streams 514 and 544, corresponding to different Tx antennas, denoted Antenna #0 and Antenna #1, respectively. This spatial mapping of the two pilot sequences 530 and 540 to the same OFDM symbol in time may be in contrast to a mapping of two pilot sequences to two respective subsequent OFDM symbols in time.

In some demonstrative embodiments, a repetition of the pilot sequence s530 and 540 may be mapped to a subsequent OFDM symbol in time, e.g., the OFDM symbol 545, e.g., as described below. Accordingly, generation of a new pilot sequence may not be needed, for example, for the subsequent OFDM symbol in time.

In some demonstrative embodiments, as shown in FIG. 5, for the subsequent OFDM symbol 545 in time, e.g., the symbol #2 in FIG. 5, the pilot sequence P2 may be, for example, repeated in the spatial stream 514 with sign inversion, and the pilot sequence P1 may be repeated in the stream 544.

For example, as shown in FIG. 5, a repeated pilot sequence 542 may include a repetition of the pilot sequence 540 with time inversion, e.g., the sequence (−P2).

For example, as shown in FIG. 5, the repeated pilot sequence 542 may be mapped to subcarriers of OFDM symbol 545 in spatial stream 514, and a repetition of the pilot sequence 530 mapped to subcarriers of OFDM symbol 545 in spatial stream 544.

In some demonstrative embodiments, the repeated pilot sequences 530 and 542 in the OFDM symbol 545 may be mapped to the same subcarrier indexes.

In some demonstrative embodiments, as shown in FIG. 5, the pilot subcarriers of the pilot sequences 530 and/or 540 may be mapped to pilot subcarriers between data subcarriers of spatial streams 514 and/or 544.

In one example, OFDM symbol 515 may include the data subcarriers of OFDM symbol 304 (FIG. 3), and/or OFDM symbol 545 may include the data subcarriers of OFDM symbol 306 (FIG. 3). For example, OFDM symbol 515 in spatial stream 514 may include pilot subcarriers of pilot sequence 530 and data subcarriers 308 (FIG. 3), OFDM symbol 515 in spatial stream 544 may include pilot subcarriers of pilot sequence 540 and data subcarriers 328 (FIG. 3), OFDM symbol 545 in spatial stream 514 may include pilot subcarriers of repeated pilot sequence 542 and data subcarriers 310 (FIG. 3), and/or OFDM symbol 545 in spatial stream 544 may include pilot subcarriers of repeated pilot sequence 530 and data subcarriers 330 (FIG. 3).

In some demonstrative embodiments, it may not be required to apply complex conjugation to the pilot symbols, e.g., according to an Alamouti scheme, for example, since the pilots may include real value signals.

In some demonstrative embodiments, one or more additional pairs of pilot sequences may be mapped to one or more respective subsequent OFDM symbols in time of spatial streams 514 and 544.

For example, a third pilot sequence having a third index, e.g., n=3, and a fourth pilot sequence having a fourth index, e.g., n=4, subsequent to the third index, may be mapped to subcarriers of third and fourth OFDM symbols of the spatial streams 514 and 544.

For example, the third pilot sequence may be mapped to a plurality of subcarriers in the third OFDM symbol of spatial stream 514, the fourth pilot sequence may be mapped to a plurality of subcarriers in the third OFDM symbol of the spatial stream 544, a repetition of the fourth pilot sequence with sign inversion may be mapped to a plurality of subcarriers in the fourth OFDM symbol of the spatial stream 514, and/or a repetition of the third pilot sequence may be mapped to a plurality of subcarriers in the fourth OFDM symbol of the spatial stream 544.

Referring back to FIG. 1, in some demonstrative embodiments, controller 154 may be configured to cause, trigger, and/or control a wireless station implemented by device 140 to process a MIMO transmission received from another station, for example, the station implemented by device 102, e.g., as described below.

In some demonstrative embodiments, the received MIMO transmission may include a plurality of spatial streams, e.g., as described above.

In some demonstrative embodiments, controller 154 may be configured to cause, trigger, and/or control the wireless station implemented by device 140 to process the received MIMO transmission, for example, in accordance with a diversity mapping scheme, for example, the mapping scheme 300 (FIG. 3) and/or the pilot mapping scheme 500 (FIG. 5), e.g., as described below.

In some demonstrative embodiments, controller 154 may include, operate as, and/or perform the functionality of a demodulator 157, which may be configured to process the plurality of spatial streams to demodulate the MIMO transmission, e.g., as described below.

In some demonstrative embodiments, demodulator 157 may be configured to demodulate the pilot signals from the MIMO transmission, for example, according to the pilot mapping scheme 500 (FIG. 5), e.g., as described below.

In some demonstrative embodiments, at the receiver side, e.g., at device 140, a space-time demodulation technique, e.g., an Alamouti demodulation technique, may be used, for example, to combine a plurality of pilot signals, for example, four pilot signals, for the same subcarrier with an index k and a plurality of OFDM symbols, for example, four OFDM symbols from the first and second spatial streams, for example, in accordance with the mapping scheme 500 (FIG. 5).

In some demonstrative embodiments, the received pilot signals at a time, denoted t, and a subsequent time, denoted t+T, may be represented, for example, as follows:

r₀=r(t)=H₀S₀+H₁S₁+n₀

r₁=r(t+T)=H₀(−S₁*)+H₁(S₀*)+n₁ (1)

wherein n₀ and n₁ denote noise samples, and S₀ and S₁ denote transmitted pilot signals from the respective sequences P1 and P2.

In some demonstrative embodiments, first and second estimated pilot signals, denoted S₀^{~} and S₁^{~}, may be determined, for example, as follows:

\tilde{S}₀=H₀*r₀+H₁r₁*

\tilde{S}₁=H₁*r₀−H₀r₁* (2)

In some demonstrative embodiments, the estimated pilot signals S₀^{~} and S₁^{~} may be, for example, determined as follows:

$$\tilde{⇒ {S}_{0}} = ( {\vert {H}_{0} \vert}^{2} + {\vert {H}_{1} \vert}^{2} ) {S}_{0} + \underbrace{{H}_{0}^{*} {H}_{1} {S}_{1} - {H}_{0}^{*} {H}_{1} {S}_{1}}_{= 0} + {H}_{1} {n}_{1}^{*} + {H}_{0}^{*} {n}_{0} \\ ⇒ {\tilde{S}}_{1} = ( {\vert {H}_{0} \vert}^{2} + {\vert {H}_{1} \vert}^{2} ) {S}_{1} + \underbrace{{H}_{1}^{*} {H}_{0} {S}_{0} - {H}_{1}^{*} {H}_{0} {S}_{0}}_{= 0} + {H}_{1}^{*} {n}_{0} - {H}_{0} {n}_{1}^{*} \qquad ( 3 )$$

In some demonstrative embodiments, the demodulation scheme described above may combine the channel gain, and/or may cancel out the inter stream components.

In some demonstrative embodiments, the estimated pilot subcarriers may be used, for example, for estimations in a modem receiver chain.

In some demonstrative embodiments, the demodulation scheme may be configured with respect to a transmission received via two receive antennas, e.g., as described above. In other embodiments, the demodulation scheme may be generalized for any other number of Rx antennas.

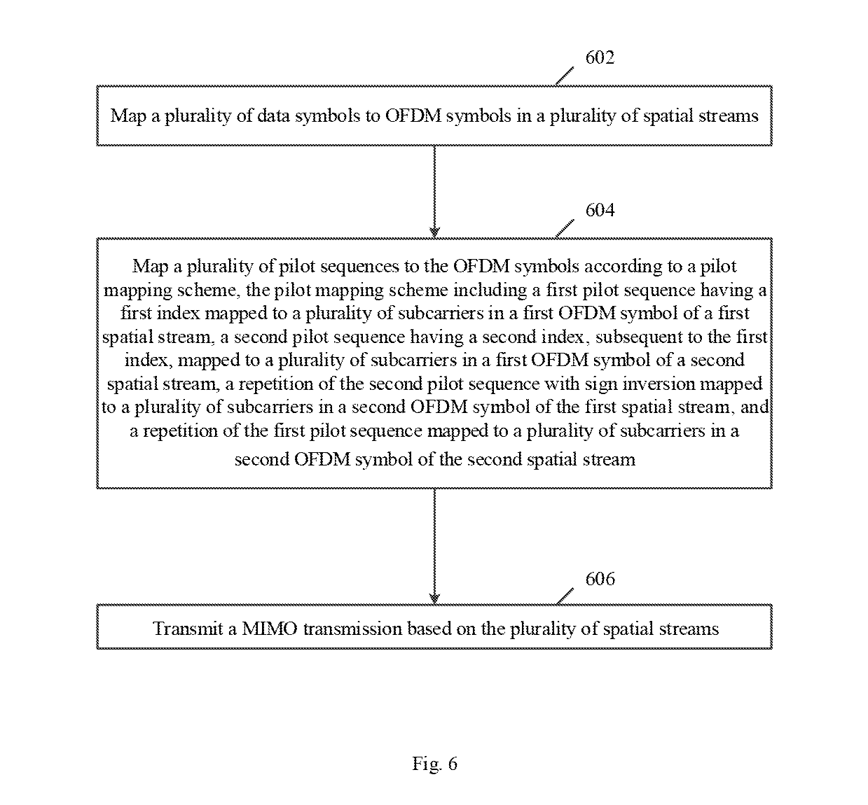

Reference is made to FIG. 6, which schematically illustrates a method of transmitting a transmission including pilot signals according to a transmit diversity scheme, in accordance with some demonstrative embodiments. For example, one or more of the operations of the method of FIG. 6 may be performed by one or more elements of a system, e.g., system 100 (FIG. 1), for example, one or more wireless devices, e.g., device 102 (FIG. 1), and/or device 140 (FIG. 1), a controller, e.g., controller 124 (FIG. 1) and/or controller 154 (FIG. 1), a mapper, e.g., mapper 129 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 602, the method may include mapping a plurality of data symbols to OFDM symbols in a plurality of spatial streams. For example, mapper 129 (FIG. 1) may be configured to cause, trigger, and/or control the wireless station implemented by device 102 (FIG. 1) to map the plurality of data symbols to OFDM symbols in a plurality of spatial streams, e.g., as described above.

As indicated at block 604, the method may include mapping a plurality of pilot sequences to the OFDM symbols according to a pilot mapping scheme.

In some demonstrative embodiments, the pilot mapping scheme may include a first pilot sequence having a first index mapped to a plurality of subcarriers in a first OFDM symbol of a first spatial stream, a second pilot sequence having a second index, subsequent to the first index, mapped to a plurality of subcarriers in a first OFDM symbol of a second spatial stream, a repetition of the second pilot sequence with sign inversion mapped to a plurality of subcarriers in a second OFDM symbol of the first spatial stream, and/or a repetition of the first pilot sequence mapped to a plurality of subcarriers in a second OFDM symbol of the second spatial stream.

For example, mapper 129 (FIG. 1) may be configured to cause, trigger, and/or control the wireless station implemented by device 102 (FIG. 1) to map a plurality of pilot sequences to the OFDM symbols according to pilot mapping scheme 500 (FIG. 5), e.g., as described above.

As indicated at block 606, the method may include transmitting a MIMO transmission based on the plurality of spatial streams. For example, controller 124 (FIG. 1) may be configured to cause, trigger, and/or control the wireless station implemented by device 102 (FIG. 1) to transmit the MIMO transmission based on the plurality of spatial streams, e.g., as described above.

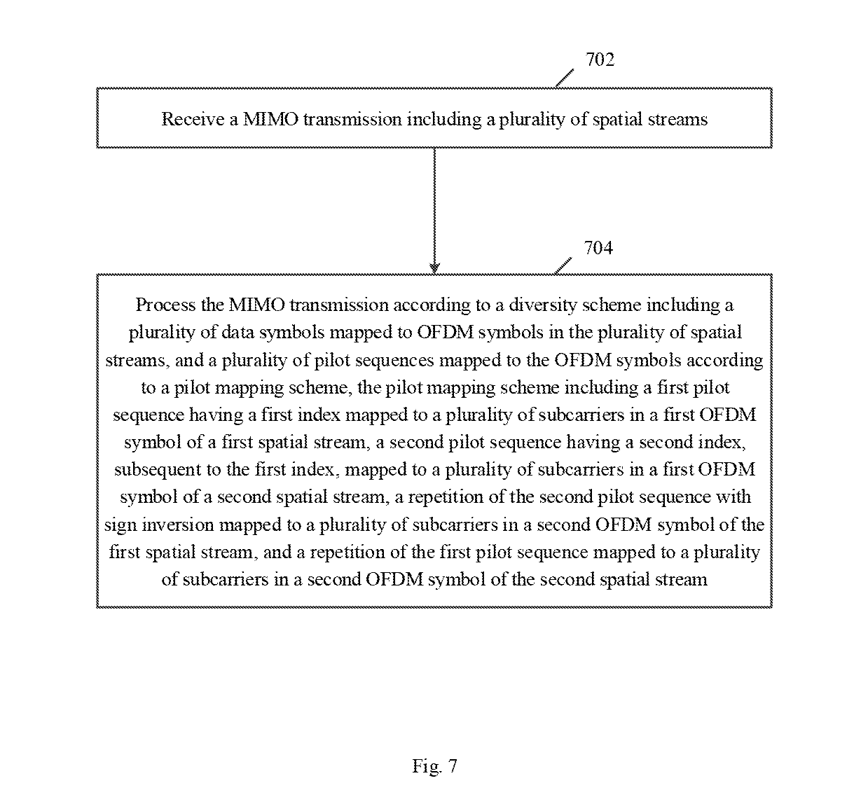

Reference is made to FIG. 7, which schematically illustrates a method of processing a received transmission including pilot signals according to a transmit diversity scheme, in accordance with some demonstrative embodiments. For example, one or more of the operations of the method of FIG. 7 may be performed by one or more elements of a system, e.g., system 100 (FIG. 1), for example, one or more wireless devices, e.g., device 102 (FIG. 1), and/or device 140 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 702, the method may include receiving a MIMO transmission including a plurality of spatial streams. For example, controller 154 (FIG. 1) may be configured to cause, trigger, and/or control the wireless station implemented by device 140 (FIG. 1) to receive from device 102 (FIG. 1) the MIMO transmission including the plurality of spatial streams, e.g., as described above.

As indicated at block 704, the method may include processing the MIMO transmission according to a diversity scheme including a plurality of data symbols mapped to OFDM symbols in the plurality of spatial streams, and a plurality of pilot sequences mapped to the OFDM symbols according to a pilot mapping scheme.

In some demonstrative embodiments, the pilot mapping scheme may include a first pilot sequence having a first index mapped to a plurality of subcarriers in a first OFDM symbol of a first spatial stream, a second pilot sequence having a second index, subsequent to the first index, mapped to a plurality of subcarriers in a first OFDM symbol of a second spatial stream, a repetition of the second pilot sequence with sign inversion mapped to a plurality of subcarriers in a second OFDM symbol of the first spatial stream, and/or a repetition of the first pilot sequence mapped to a plurality of subcarriers in a second OFDM symbol of the second spatial stream, e.g., as described above.

For example, controller 154 (FIG. 1) may be configured to cause, trigger, and/or control the wireless station implemented by device 140 (FIG. 1) to process the MIMO transmission according to the diversity scheme 300 (FIG. 3) and the pilot mapping scheme 500 (FIG. 5), e.g., as described above.

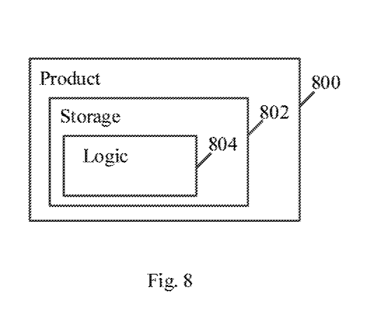

Reference is made to FIG. 8, which schematically illustrates a product of manufacture 800, in accordance with some demonstrative embodiments. Product 800 may include one or more tangible computer-readable non-transitory storage media 802, which may include computer-executable instructions, e.g., implemented by logic 804, operable to, when executed by at least one computer processor, enable the at least one computer processor to implement one or more operations at devices 102 and/or 140 (FIG. 1), transmitters 118 and/or 148 (FIG. 1), receivers 116 and/or 146 (FIG. 1), controllers 124 and/or 154 (FIG. 1), message processors 128 (FIG. 1) and/or 158 (FIG. 1), pilot generator 127 (FIG. 1), mapper 129 (FIG. 1), and/or demodulator 157 (FIG. 1), and/or to perform, trigger and/or implement one or more operations and/or functionalities, for example, one or more operations and/or functionalities described above, e.g., with reference to FIGS. 1, 2, 3, 4, 5, 6, and/or 7. The phrase “non-transitory machine-readable medium” is directed to include all computer-readable media, with the sole exception being a transitory propagating signal.

In some demonstrative embodiments, product 800 and/or storage media 802 may include one or more types of computer-readable storage media capable of storing data, including volatile memory, non-volatile memory, removable or non-removable memory, erasable or non-erasable memory, writeable or re-writeable memory, and the like. For example, storage media 802 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 804 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 804 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### EXAMPLES

The following examples pertain to further embodiments.

Example 1 includes an apparatus comprising logic and circuitry configured to cause a wireless station to map a plurality of data symbols to Orthogonal Frequency-Division Multiplexing (OFDM) symbols in a plurality of spatial streams; map a plurality of pilot sequences to the OFDM symbols according to a pilot mapping scheme comprising a first pilot sequence having a first index mapped to a plurality of subcarriers in a first OFDM symbol of a first spatial stream, a second pilot sequence having a second index, subsequent to the first index, mapped to a plurality of subcarriers in a first OFDM symbol of a second spatial stream, a repetition of the second pilot sequence with sign inversion mapped to a plurality of subcarriers in a second OFDM symbol of the first spatial stream, and a repetition of the first pilot sequence mapped to a plurality of subcarriers in a second OFDM symbol of the second spatial stream; and transmit a Multi-In-Multi-Out (MIMO) transmission based on the plurality of spatial streams.

Example 2 includes the subject matter of Example 1, and optionally, wherein the pilot mapping scheme comprises a third pilot sequence having a third index, subsequent to the second index, mapped to a plurality of subcarriers in a third OFDM symbol of the first spatial stream, a fourth pilot sequence having a fourth index, subsequent to the third index, mapped to a plurality of subcarriers in a third OFDM symbol of the second spatial stream, a repetition of the fourth pilot sequence with sign inversion mapped to a plurality of subcarriers in a fourth OFDM symbol of the first spatial stream, and a repetition of the third pilot sequence mapped to a plurality of subcarriers in a fourth OFDM symbol of the second spatial stream.

Example 3 includes the subject matter of Example 1 or 2, and optionally, wherein each of the first and second pilot sequences comprises sixteen pilot subcarriers.

Example 4 includes the subject matter of Example 3, and optionally, wherein the sixteen pilot subcarriers are evenly spaced.

Example 5 includes the subject matter of Example 4, and optionally, wherein two adjacent pilot subcarriers are 20 subcarriers apart.

Example 6 includes the subject matter of any one of Examples 3-5, and optionally, wherein the sixteen subcarriers comprise subcarriers with subcarrier indexes of [−150, −130, −110, −90, −70, −50, −30, −10, 10, 30, 50, 70, 90, 110, 130, 150].

Example 7 includes the subject matter of any one of Examples 1-6, and optionally, wherein the apparatus is configured to cause the wireless station to generate a pilot sequence having an index n by applying to a predefined pilot sequence a function, which is based on a value of n.

Example 8 includes the subject matter of Example 7, and optionally, wherein the predefined pilot sequence comprises the sequence [−1, 1, −1, 1, 1, −1, −1, −1, −1, −1, 1, 1, 1, −1, 1, 1].

Example 9 includes the subject matter of any one of Examples 1-8, and optionally, wherein the MIMO transmission comprises a 2×N MIMO transmission comprising two spatial transmit streams via two respective antennas.

Example 10 includes the subject matter of any one of Examples 1-9, and optionally, wherein the apparatus is configured to cause the wireless station to transmit the MIMO transmission over a Directional Multi-Gigabit (DMG) band.

Example 11 includes the subject matter of any one of Examples 1-10, and optionally, wherein the wireless station is a Directional Multi-Gigabit (DMG) Station (STA).

Example 12 includes the subject matter of any one of Examples 1-11, and optionally, comprising one or more antennas, a memory, and a processor.

Example 13 includes a system of wireless communication comprising a wireless station, the wireless station comprising one or more antennas; a memory; a processor; and a controller configured to cause the wireless station to map a plurality of data symbols to Orthogonal Frequency-Division Multiplexing (OFDM) symbols in a plurality of spatial streams; map a plurality of pilot sequences to the OFDM symbols according to a pilot mapping scheme comprising a first pilot sequence having a first index mapped to a plurality of subcarriers in a first OFDM symbol of a first spatial stream, a second pilot sequence having a second index, subsequent to the first index, mapped to a plurality of subcarriers in a first OFDM symbol of a second spatial stream, a repetition of the second pilot sequence with sign inversion mapped to a plurality of subcarriers in a second OFDM symbol of the first spatial stream, and a repetition of the first pilot sequence mapped to a plurality of subcarriers in a second OFDM symbol of the second spatial stream; and transmit a Multi-In-Multi-Out (MIMO) transmission based on the plurality of spatial streams.

Example 14 includes the subject matter of Example 13, and optionally, wherein the pilot mapping scheme comprises a third pilot sequence having a third index, subsequent to the second index, mapped to a plurality of subcarriers in a third OFDM symbol of the first spatial stream, a fourth pilot sequence having a fourth index, subsequent to the third index, mapped to a plurality of subcarriers in a third OFDM symbol of the second spatial stream, a repetition of the fourth pilot sequence with sign inversion mapped to a plurality of subcarriers in a fourth OFDM symbol of the first spatial stream, and a repetition of the third pilot sequence mapped to a plurality of subcarriers in a fourth OFDM symbol of the second spatial stream.

Example 15 includes the subject matter of Example 13 or 14, and optionally, wherein each of the first and second pilot sequences comprises sixteen pilot subcarriers.

Example 16 includes the subject matter of Example 15, and optionally, wherein the sixteen pilot subcarriers are evenly spaced.

Example 17 includes the subject matter of Example 16, and optionally, wherein two adjacent pilot subcarriers are 20 subcarriers apart.

Example 18 includes the subject matter of any one of Examples 15-17, and optionally, wherein the sixteen subcarriers comprise subcarriers with subcarrier indexes of [−150, −130, −110, −90, −70, −50, −30, −10, 10, 30, 50, 70, 90, 110, 130, 150].

Example 19 includes the subject matter of any one of Examples 13-18, and optionally, wherein the controller is configured to cause the wireless station to generate a pilot sequence having an index n by applying to a predefined pilot sequence a function, which is based on a value of n.

Example 20 includes the subject matter of Example 19, and optionally, wherein the predefined pilot sequence comprises the sequence [−1, 1, −1, 1, 1, −1, −1, −1, −1, −1, 1, 1, 1, −1, 1, 1].

Example 21 includes the subject matter of any one of Examples 13-20, and optionally, wherein the MIMO transmission comprises a 2×N MIMO transmission comprising two spatial transmit streams via two respective antennas.

Example 22 includes the subject matter of any one of Examples 13-21, and optionally, wherein the controller is configured to cause the wireless station to transmit the MIMO transmission over a Directional Multi-Gigabit (DMG) band.

Example 23 includes the subject matter of any one of Examples 13-22, and optionally, wherein the wireless station is a Directional Multi-Gigabit (DMG) Station (STA).

Example 24 includes a method to be performed at a wireless station, the method comprising mapping a plurality of data symbols to Orthogonal Frequency-Division Multiplexing (OFDM) symbols in a plurality of spatial streams; mapping a plurality of pilot sequences to the OFDM symbols according to a pilot mapping scheme comprising a first pilot sequence having a first index mapped to a plurality of subcarriers in a first OFDM symbol of a first spatial stream, a second pilot sequence having a second index, subsequent to the first index, mapped to a plurality of subcarriers in a first OFDM symbol of a second spatial stream, a repetition of the second pilot sequence with sign inversion mapped to a plurality of subcarriers in a second OFDM symbol of the first spatial stream, and a repetition of the first pilot sequence mapped to a plurality of subcarriers in a second OFDM symbol of the second spatial stream; and transmitting a Multi-In-Multi-Out (MIMO) transmission based on the plurality of spatial streams.

Example 25 includes the subject matter of Example 24, and optionally, wherein the pilot mapping scheme comprises a third pilot sequence having a third index, subsequent to the second index, mapped to a plurality of subcarriers in a third OFDM symbol of the first spatial stream, a fourth pilot sequence having a fourth index, subsequent to the third index, mapped to a plurality of subcarriers in a third OFDM symbol of the second spatial stream, a repetition of the fourth pilot sequence with sign inversion mapped to a plurality of subcarriers in a fourth OFDM symbol of the first spatial stream, and a repetition of the third pilot sequence mapped to a plurality of subcarriers in a fourth OFDM symbol of the second spatial stream.

Example 26 includes the subject matter of Example 24 or 25, and optionally, wherein each of the first and second pilot sequences comprises sixteen pilot subcarriers.

Example 27 includes the subject matter of Example 26, and optionally, wherein the sixteen pilot subcarriers are evenly spaced.

Example 28 includes the subject matter of Example 27, and optionally, wherein two adjacent pilot subcarriers are 20 subcarriers apart.

Example 29 includes the subject matter of any one of Examples 26-28, and optionally, wherein the sixteen subcarriers comprise subcarriers with subcarrier indexes of [−150, −130, −110, −90, −70, −50, −30, −10, 10, 30, 50, 70, 90, 110, 130, 150].

Example 30 includes the subject matter of any one of Examples 24-29, and optionally, comprising generating a pilot sequence having an index n by applying to a predefined pilot sequence a function, which is based on a value of n.

Example 31 includes the subject matter of Example 30, and optionally, wherein the predefined pilot sequence comprises the sequence [−1, 1, −1, 1, 1, −1, −1, −1, −1, −1, 1, 1, 1, −1, 1, 1].

Example 32 includes the subject matter of any one of Examples 24-31, and optionally, wherein the MIMO transmission comprises a 2×N MIMO transmission comprising two spatial transmit streams via two respective antennas.

Example 33 includes the subject matter of any one of Examples 24-32, and optionally, comprising transmitting the MIMO transmission over a Directional Multi-Gigabit (DMG) band.

Example 34 includes the subject matter of any one of Examples 24-33, and optionally, wherein the wireless station is a Directional Multi-Gigabit (DMG) Station (STA).

Example 35 includes a product comprising one or more tangible computer-readable non-transitory storage media comprising computer-executable instructions operable to, when executed by at least one computer processor, enable the at least one computer processor to implement operations at a wireless station, the operations comprising mapping a plurality of data symbols to Orthogonal Frequency-Division Multiplexing (OFDM) symbols in a plurality of spatial streams; mapping a plurality of pilot sequences to the OFDM symbols according to a pilot mapping scheme comprising a first pilot sequence having a first index mapped to a plurality of subcarriers in a first OFDM symbol of a first spatial stream, a second pilot sequence having a second index, subsequent to the first index, mapped to a plurality of subcarriers in a first OFDM symbol of a second spatial stream, a repetition of the second pilot sequence with sign inversion mapped to a plurality of subcarriers in a second OFDM symbol of the first spatial stream, and a repetition of the first pilot sequence mapped to a plurality of subcarriers in a second OFDM symbol of the second spatial stream; and transmitting a Multi-In-Multi-Out (MIMO) transmission based on the plurality of spatial streams.

Example 36 includes the subject matter of Example 35, and optionally, wherein the pilot mapping scheme comprises a third pilot sequence having a third index, subsequent to the second index, mapped to a plurality of subcarriers in a third OFDM symbol of the first spatial stream, a fourth pilot sequence having a fourth index, subsequent to the third index, mapped to a plurality of subcarriers in a third OFDM symbol of the second spatial stream, a repetition of the fourth pilot sequence with sign inversion mapped to a plurality of subcarriers in a fourth OFDM symbol of the first spatial stream, and a repetition of the third pilot sequence mapped to a plurality of subcarriers in a fourth OFDM symbol of the second spatial stream.

Example 37 includes the subject matter of Example 35 or 36, and optionally, wherein each of the first and second pilot sequences comprises sixteen pilot subcarriers.

Example 38 includes the subject matter of Example 37, and optionally, wherein the sixteen pilot subcarriers are evenly spaced.

Example 39 includes the subject matter of Example 38, and optionally, wherein two adjacent pilot subcarriers are 20 subcarriers apart.

Example 40 includes the subject matter of any one of Examples 37-39, and optionally, wherein the sixteen subcarriers comprise subcarriers with subcarrier indexes of [−150, −130, −110, −90, −70, −50, −30, −10, 10, 30, 50, 70, 90, 110, 130, 150].

Example 41 includes the subject matter of any one of Examples 35-40, and optionally, wherein the operations comprise generating a pilot sequence having an index n by applying to a predefined pilot sequence a function, which is based on a value of n.

Example 42 includes the subject matter of Example 41, and optionally, wherein the predefined pilot sequence comprises the sequence [−1, 1, −1, 1, 1, −1, −1, −1, −1, −1, 1, 1, 1, −1, 1, 1].

Example 43 includes the subject matter of any one of Examples 35-42, and optionally, wherein the MIMO transmission comprises a 2×N MIMO transmission comprising two spatial transmit streams via two respective antennas.

Example 44 includes the subject matter of any one of Examples 35-43, and optionally, wherein the operations comprise transmitting the MIMO transmission over a Directional Multi-Gigabit (DMG) band.

Example 45 includes the subject matter of any one of Examples 35-44, and optionally, wherein the wireless station is a Directional Multi-Gigabit (DMG) Station (STA).

Example 46 includes an apparatus of a wireless station, the apparatus comprising means for mapping a plurality of data symbols to Orthogonal Frequency-Division Multiplexing (OFDM) symbols in a plurality of spatial streams; means for mapping a plurality of pilot sequences to the OFDM symbols according to a pilot mapping scheme comprising a first pilot sequence having a first index mapped to a plurality of subcarriers in a first OFDM symbol of a first spatial stream, a second pilot sequence having a second index, subsequent to the first index, mapped to a plurality of subcarriers in a first OFDM symbol of a second spatial stream, a repetition of the second pilot sequence with sign inversion mapped to a plurality of subcarriers in a second OFDM symbol of the first spatial stream, and a repetition of the first pilot sequence mapped to a plurality of subcarriers in a second OFDM symbol of the second spatial stream; and means for transmitting a Multi-In-Multi-Out (MIMO) transmission based on the plurality of spatial streams.

Example 47 includes the subject matter of Example 46, and optionally, wherein the pilot mapping scheme comprises a third pilot sequence having a third index, subsequent to the second index, mapped to a plurality of subcarriers in a third OFDM symbol of the first spatial stream, a fourth pilot sequence having a fourth index, subsequent to the third index, mapped to a plurality of subcarriers in a third OFDM symbol of the second spatial stream, a repetition of the fourth pilot sequence with sign inversion mapped to a plurality of subcarriers in a fourth OFDM symbol of the first spatial stream, and a repetition of the third pilot sequence mapped to a plurality of subcarriers in a fourth OFDM symbol of the second spatial stream.

Example 48 includes the subject matter of Example 46 or 47, and optionally, wherein each of the first and second pilot sequences comprises sixteen pilot subcarriers.

Example 49 includes the subject matter of Example 48, and optionally, wherein the sixteen pilot subcarriers are evenly spaced.

Example 50 includes the subject matter of Example 49, and optionally, wherein two adjacent pilot subcarriers are 20 subcarriers apart.

Example 51 includes the subject matter of any one of Examples 48-50, and optionally, wherein the sixteen subcarriers comprise subcarriers with subcarrier indexes of [−150, −130, −110, −90, −70, −50, −30, −10, 10, 30, 50, 70, 90, 110, 130, 150].

Example 52 includes the subject matter of any one of Examples 46-51, and optionally, comprising means for generating a pilot sequence having an index n by applying to a predefined pilot sequence a function, which is based on a value of n.

Example 53 includes the subject matter of Example 52, and optionally, wherein the predefined pilot sequence comprises the sequence [−1, 1, −1, 1, 1, −1, −1, −1, −1, −1, 1, 1, 1, −1, 1, 1].

Example 54 includes the subject matter of any one of Examples 46-53, and optionally, wherein the MIMO transmission comprises a 2×N MIMO transmission comprising two spatial transmit streams via two respective antennas.

Example 55 includes the subject matter of any one of Examples 46-54, and optionally, comprising means for transmitting the MIMO transmission over a Directional Multi-Gigabit (DMG) band.

Example 56 includes the subject matter of any one of Examples 46-55, and optionally, wherein the wireless station is a Directional Multi-Gigabit (DMG) Station (STA).

Example 57 includes an apparatus comprising logic and circuitry configured to cause a wireless station to receive a Multi-In-Multi-Out (MIMO) transmission comprising a plurality of spatial streams; and process the MIMO transmission according to a diversity scheme comprising a plurality of data symbols mapped to Orthogonal Frequency-Division Multiplexing (OFDM) symbols in the plurality of spatial streams, and a plurality of pilot sequences mapped to the OFDM symbols according to a pilot mapping scheme, the pilot mapping scheme comprising a first pilot sequence having a first index mapped to a plurality of subcarriers in a first OFDM symbol of a first spatial stream, a second pilot sequence having a second index, subsequent to the first index, mapped to a plurality of subcarriers in a first OFDM symbol of a second spatial stream, a repetition of the second pilot sequence with sign inversion mapped to a plurality of subcarriers in a second OFDM symbol of the first spatial stream, and a repetition of the first pilot sequence mapped to a plurality of subcarriers in a second OFDM symbol of the second spatial stream.

Example 58 includes the subject matter of Example 57, and optionally, wherein the pilot mapping scheme comprises a third pilot sequence having a third index, subsequent to the second index, mapped to a plurality of subcarriers in a third OFDM symbol of the first spatial stream, a fourth pilot sequence having a fourth index, subsequent to the third index, mapped to a plurality of subcarriers in a third OFDM symbol of the second spatial stream, a repetition of the fourth pilot sequence with sign inversion mapped to a plurality of subcarriers in a fourth OFDM symbol of the first spatial stream, and a repetition of the third pilot sequence mapped to a plurality of subcarriers in a fourth OFDM symbol of the second spatial stream.

Example 59 includes the subject matter of Example 57 or 58, and optionally, wherein each of the first and second pilot sequences comprises sixteen pilot subcarriers.

Example 60 includes the subject matter of Example 59, and optionally, wherein the sixteen pilot subcarriers are evenly spaced.

Example 61 includes the subject matter of Example 60, and optionally, wherein two adjacent pilot subcarriers are 20 subcarriers apart.

Example 62 includes the subject matter of any one of Examples 59-61, and optionally, wherein the sixteen subcarriers comprise subcarriers with subcarrier indexes of [−150, −130, −110, −90, −70, −50, −30, −10, 10, 30, 50, 70, 90, 110, 130, 150].

Example 63 includes the subject matter of any one of Examples 57-62, and optionally, wherein the MIMO transmission comprises a 2×N MIMO transmission comprising two spatial transmit streams.

Example 64 includes the subject matter of any one of Examples 57-63, and optionally, wherein the apparatus is configured to cause the wireless station to receive the MIMO transmission over a Directional Multi-Gigabit (DMG) band.

Example 65 includes the subject matter of any one of Examples 57-64, and optionally, wherein the wireless station is a Directional Multi-Gigabit (DMG) Station (STA).

Example 66 includes the subject matter of any one of Examples 57-65, and optionally, comprising one or more antennas, a memory, and a processor.

Example 67 includes a system of wireless communication comprising a wireless station, the wireless station comprising one or more antennas; a memory; a processor; and a controller configured to cause the wireless station to receive a Multi-In-Multi-Out (MIMO) transmission comprising a plurality of spatial streams; and process the MIMO transmission according to a diversity scheme comprising a plurality of data symbols mapped to Orthogonal Frequency-Division Multiplexing (OFDM) symbols in the plurality of spatial streams, and a plurality of pilot sequences mapped to the OFDM symbols according to a pilot mapping scheme, the pilot mapping scheme comprising a first pilot sequence having a first index mapped to a plurality of subcarriers in a first OFDM symbol of a first spatial stream, a second pilot sequence having a second index, subsequent to the first index, mapped to a plurality of subcarriers in a first OFDM symbol of a second spatial stream, a repetition of the second pilot sequence with sign inversion mapped to a plurality of subcarriers in a second OFDM symbol of the first spatial stream, and a repetition of the first pilot sequence mapped to a plurality of subcarriers in a second OFDM symbol of the second spatial stream.

Example 68 includes the subject matter of Example 67, and optionally, wherein the pilot mapping scheme comprises a third pilot sequence having a third index, subsequent to the second index, mapped to a plurality of subcarriers in a third OFDM symbol of the first spatial stream, a fourth pilot sequence having a fourth index, subsequent to the third index, mapped to a plurality of subcarriers in a third OFDM symbol of the second spatial stream, a repetition of the fourth pilot sequence with sign inversion mapped to a plurality of subcarriers in a fourth OFDM symbol of the first spatial stream, and a repetition of the third pilot sequence mapped to a plurality of subcarriers in a fourth OFDM symbol of the second spatial stream.

Example 69 includes the subject matter of Example 67 or 68, and optionally, wherein each of the first and second pilot sequences comprises sixteen pilot subcarriers.

Example 70 includes the subject matter of Example 69, and optionally, wherein the sixteen pilot subcarriers are evenly spaced.

Example 71 includes the subject matter of Example 70, and optionally, wherein two adjacent pilot subcarriers are 20 subcarriers apart.

Example 72 includes the subject matter of any one of Examples 69-71, and optionally, wherein the sixteen subcarriers comprise subcarriers with subcarrier indexes of [−150, −130, −110, −90, −70, −50, −30, −10, 10, 30, 50, 70, 90, 110, 130, 150].

Example 73 includes the subject matter of any one of Examples 67-72, and optionally, wherein the MIMO transmission comprises a 2×N MIMO transmission comprising two spatial transmit streams.

Example 74 includes the subject matter of any one of Examples 67-73, and optionally, wherein the controller is configured to cause the wireless station to receive the MIMO transmission over a Directional Multi-Gigabit (DMG) band.

Example 75 includes the subject matter of any one of Examples 67-74, and optionally, wherein the wireless station is a Directional Multi-Gigabit (DMG) Station (STA).

Example 76 includes a method to be performed at a wireless station, the method comprising receiving a Multi-In-Multi-Out (MIMO) transmission comprising a plurality of spatial streams; and processing the MIMO transmission according to a diversity scheme comprising a plurality of data symbols mapped to Orthogonal Frequency-Division Multiplexing (OFDM) symbols in the plurality of spatial streams, and a plurality of pilot sequences mapped to the OFDM symbols according to a pilot mapping scheme, the pilot mapping scheme comprising a first pilot sequence having a first index mapped to a plurality of subcarriers in a first OFDM symbol of a first spatial stream, a second pilot sequence having a second index, subsequent to the first index, mapped to a plurality of subcarriers in a first OFDM symbol of a second spatial stream, a repetition of the second pilot sequence with sign inversion mapped to a plurality of subcarriers in a second OFDM symbol of the first spatial stream, and a repetition of the first pilot sequence mapped to a plurality of subcarriers in a second OFDM symbol of the second spatial stream.

Example 77 includes the subject matter of Example 76, and optionally, wherein the pilot mapping scheme comprises a third pilot sequence having a third index, subsequent to the second index, mapped to a plurality of subcarriers in a third OFDM symbol of the first spatial stream, a fourth pilot sequence having a fourth index, subsequent to the third index, mapped to a plurality of subcarriers in a third OFDM symbol of the second spatial stream, a repetition of the fourth pilot sequence with sign inversion mapped to a plurality of subcarriers in a fourth OFDM symbol of the first spatial stream, and a repetition of the third pilot sequence mapped to a plurality of subcarriers in a fourth OFDM symbol of the second spatial stream.

Example 78 includes the subject matter of Example 76 or 77, and optionally, wherein each of the first and second pilot sequences comprises sixteen pilot subcarriers.

Example 79 includes the subject matter of Example 78, and optionally, wherein the sixteen pilot subcarriers are evenly spaced.

Example 80 includes the subject matter of Example 79, and optionally, wherein two adjacent pilot subcarriers are 20 subcarriers apart.

Example 81 includes the subject matter of any one of Examples 78-80, and optionally, wherein the sixteen subcarriers comprise subcarriers with subcarrier indexes of [−150, −130, −110, −90, −70, −50, −30, −10, 10, 30, 50, 70, 90, 110, 130, 150].

Example 82 includes the subject matter of any one of Examples 76-81, and optionally, wherein the MIMO transmission comprises a 2×N MIMO transmission comprising two spatial transmit streams.

Example 83 includes the subject matter of any one of Examples 76-82, and optionally, comprising receiving the MIMO transmission over a Directional Multi-Gigabit (DMG) band.

Example 84 includes the subject matter of any one of Examples 76-83, and optionally, wherein the wireless station is a Directional Multi-Gigabit (DMG) Station (STA).

Example 85 includes a product comprising one or more tangible computer-readable non-transitory storage media comprising computer-executable instructions operable to, when executed by at least one computer processor, enable the at least one computer processor to implement operations at a wireless station, the operations comprising receiving a Multi-In-Multi-Out (MIMO) transmission comprising a plurality of spatial streams; and processing the MIMO transmission according to a diversity scheme comprising a plurality of data symbols mapped to Orthogonal Frequency-Division Multiplexing (OFDM) symbols in the plurality of spatial streams, and a plurality of pilot sequences mapped to the OFDM symbols according to a pilot mapping scheme, the pilot mapping scheme comprising a first pilot sequence having a first index mapped to a plurality of subcarriers in a first OFDM symbol of a first spatial stream, a second pilot sequence having a second index, subsequent to the first index, mapped to a plurality of subcarriers in a first OFDM symbol of a second spatial stream, a repetition of the second pilot sequence with sign inversion mapped to a plurality of subcarriers in a second OFDM symbol of the first spatial stream, and a repetition of the first pilot sequence mapped to a plurality of subcarriers in a second OFDM symbol of the second spatial stream.

Example 86 includes the subject matter of Example 85, and optionally, wherein the pilot mapping scheme comprises a third pilot sequence having a third index, subsequent to the second index, mapped to a plurality of subcarriers in a third OFDM symbol of the first spatial stream, a fourth pilot sequence having a fourth index, subsequent to the third index, mapped to a plurality of subcarriers in a third OFDM symbol of the second spatial stream, a repetition of the fourth pilot sequence with sign inversion mapped to a plurality of subcarriers in a fourth OFDM symbol of the first spatial stream, and a repetition of the third pilot sequence mapped to a plurality of subcarriers in a fourth OFDM symbol of the second spatial stream.

Example 87 includes the subject matter of Example 85 or 86, and optionally, wherein each of the first and second pilot sequences comprises sixteen pilot subcarriers.

Example 88 includes the subject matter of Example 87, and optionally, wherein the sixteen pilot subcarriers are evenly spaced.

Example 89 includes the subject matter of Example 88, and optionally, wherein two adjacent pilot subcarriers are 20 subcarriers apart.

Example 90 includes the subject matter of any one of Examples 87-89, and optionally, wherein the sixteen subcarriers comprise subcarriers with subcarrier indexes of [−150, −130, −110, −90, −70, −50, −30, −10, 10, 30, 50, 70, 90, 110, 130, 150].

Example 91 includes the subject matter of any one of Examples 85-90, and optionally, wherein the MIMO transmission comprises a 2×N MIMO transmission comprising two spatial transmit streams.

Example 92 includes the subject matter of any one of Examples 85-91, and optionally, wherein the operations comprise receiving the MIMO transmission over a Directional Multi-Gigabit (DMG) band.

Example 93 includes the subject matter of any one of Examples 85-92, and optionally, wherein the wireless station is a Directional Multi-Gigabit (DMG) Station (STA).

Example 94 includes an apparatus of a wireless station, the apparatus comprising means for receiving a Multi-In-Multi-Out (MIMO) transmission comprising a plurality of spatial streams; and means for processing the MIMO transmission according to a diversity scheme comprising a plurality of data symbols mapped to Orthogonal Frequency-Division Multiplexing (OFDM) symbols in the plurality of spatial streams, and a plurality of pilot sequences mapped to the OFDM symbols according to a pilot mapping scheme, the pilot mapping scheme comprising a first pilot sequence having a first index mapped to a plurality of subcarriers in a first OFDM symbol of a first spatial stream, a second pilot sequence having a second index, subsequent to the first index, mapped to a plurality of subcarriers in a first OFDM symbol of a second spatial stream, a repetition of the second pilot sequence with sign inversion mapped to a plurality of subcarriers in a second OFDM symbol of the first spatial stream, and a repetition of the first pilot sequence mapped to a plurality of subcarriers in a second OFDM symbol of the second spatial stream.

Example 95 includes the subject matter of Example 94, and optionally, wherein the pilot mapping scheme comprises a third pilot sequence having a third index, subsequent to the second index, mapped to a plurality of subcarriers in a third OFDM symbol of the first spatial stream, a fourth pilot sequence having a fourth index, subsequent to the third index, mapped to a plurality of subcarriers in a third OFDM symbol of the second spatial stream, a repetition of the fourth pilot sequence with sign inversion mapped to a plurality of subcarriers in a fourth OFDM symbol of the first spatial stream, and a repetition of the third pilot sequence mapped to a plurality of subcarriers in a fourth OFDM symbol of the second spatial stream.

Example 96 includes the subject matter of Example 94 or 95, and optionally, wherein each of the first and second pilot sequences comprises sixteen pilot subcarriers.

Example 97 includes the subject matter of Example 96, and optionally, wherein the sixteen pilot subcarriers are evenly spaced.

Example 98 includes the subject matter of Example 97, and optionally, wherein two adjacent pilot subcarriers are 20 subcarriers apart.

Example 99 includes the subject matter of any one of Examples 96-98, and optionally, wherein the sixteen subcarriers comprise subcarriers with subcarrier indexes of [−150, −130, −110, −90, −70, −50, −30, −10, 10, 30, 50, 70, 90, 110, 130, 150].

Example 100 includes the subject matter of any one of Examples 94-99, and optionally, wherein the MIMO transmission comprises a 2×N MIMO transmission comprising two spatial transmit streams.

Example 101 includes the subject matter of any one of Examples 94-100, and optionally, comprising means for receiving the MIMO transmission over a Directional Multi-Gigabit (DMG) band.

Example 102 includes the subject matter of any one of Examples 94-101, and optionally, wherein the wireless station is a Directional Multi-Gigabit (DMG) Station (STA).

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause a wireless station to:
map a plurality of data symbols to Orthogonal Frequency-Division Multiplexing (OFDM) symbols in a plurality of spatial streams;
map a plurality of pilot sequences to the OFDM symbols according to a pilot mapping scheme comprising a first pilot sequence having a first index mapped to a plurality of subcarriers in a first OFDM symbol of a first spatial stream, a second pilot sequence having a second index, subsequent to the first index, mapped to a plurality of subcarriers in a first OFDM symbol of a second spatial stream, a repetition of the second pilot sequence with sign inversion mapped to a plurality of subcarriers in a second OFDM symbol of the first spatial stream, and a repetition of the first pilot sequence mapped to a plurality of subcarriers in a second OFDM symbol of the second spatial stream; and
transmit a Multi-In-Multi-Out (MIMO) transmission based on the plurality of spatial streams.

2. The apparatus of claim 1, wherein the pilot mapping scheme comprises a third pilot sequence having a third index, subsequent to the second index, mapped to a plurality of subcarriers in a third OFDM symbol of the first spatial stream, a fourth pilot sequence having a fourth index, subsequent to the third index, mapped to a plurality of subcarriers in a third OFDM symbol of the second spatial stream, a repetition of the fourth pilot sequence with sign inversion mapped to a plurality of subcarriers in a fourth OFDM symbol of the first spatial stream, and a repetition of the third pilot sequence mapped to a plurality of subcarriers in a fourth OFDM symbol of the second spatial stream.

3. The apparatus of claim 1, wherein each of the first and second pilot sequences comprises sixteen pilot subcarriers.

4. The apparatus of claim 3, wherein the sixteen pilot subcarriers are evenly spaced.

5. The apparatus of claim 4, wherein two adjacent pilot subcarriers are 20 subcarriers apart.

6. The apparatus of claim 3, wherein the sixteen subcarriers comprise subcarriers with subcarrier indexes of [−150, −130, −110, −90, −70, −50, −30, −10, 10, 30, 50, 70, 90, 110, 130, 150].

7. The apparatus of claim 1 configured to cause the wireless station to generate a pilot sequence having an index n by applying to a predefined pilot sequence a function, which is based on a value of n.

8. The apparatus of claim 7, wherein the predefined pilot sequence comprises the sequence [−1, 1, −1, 1, 1, −1, −1, −1, −1, −1, 1, 1, 1, −1, 1, 1].

9. The apparatus of claim 1, wherein the MIMO transmission comprises a 2×N MIMO transmission comprising two spatial transmit streams via two respective antennas.

10. The apparatus of claim 1 configured to cause the wireless station to transmit the MIMO transmission over a Directional Multi-Gigabit (DMG) band.

11. The apparatus of claim 1, wherein the wireless station is a Directional Multi-Gigabit (DMG) Station (STA).

12. The apparatus of claim 1 comprising one or more antennas, a memory, and a processor.

13. A product comprising one or more tangible computer-readable non-transitory storage media comprising computer-executable instructions operable to, when executed by at least one computer processor, enable the at least one computer processor to implement operations at a wireless station, the operations comprising:
mapping a plurality of data symbols to Orthogonal Frequency-Division Multiplexing (OFDM) symbols in a plurality of spatial streams;
mapping a plurality of pilot sequences to the OFDM symbols according to a pilot mapping scheme comprising a first pilot sequence having a first index mapped to a plurality of subcarriers in a first OFDM symbol of a first spatial stream, a second pilot sequence having a second index, subsequent to the first index, mapped to a plurality of subcarriers in a first OFDM symbol of a second spatial stream, a repetition of the second pilot sequence with sign inversion mapped to a plurality of subcarriers in a second OFDM symbol of the first spatial stream, and a repetition of the first pilot sequence mapped to a plurality of subcarriers in a second OFDM symbol of the second spatial stream; and
transmitting a Multi-In-Multi-Out (MIMO) transmission based on the plurality of spatial streams.

14. The product of claim 13, wherein each of the first and second pilot sequences comprises sixteen pilot subcarriers.

15. The product of claim 13, wherein the operations comprise generating a pilot sequence having an index n by applying to a predefined pilot sequence a function, which is based on a value of n.

16. The product of claim 13, wherein the MIMO transmission comprises a 2×N MIMO transmission comprising two spatial transmit streams via two respective antennas.

17. An apparatus comprising logic and circuitry configured to cause a wireless station to:
receive a Multi-In-Multi-Out (MIMO) transmission comprising a plurality of spatial streams; and
process the MIMO transmission according to a diversity scheme comprising a plurality of data symbols mapped to Orthogonal Frequency-Division Multiplexing (OFDM) symbols in the plurality of spatial streams, and a plurality of pilot sequences mapped to the OFDM symbols according to a pilot mapping scheme, the pilot mapping scheme comprising a first pilot sequence having a first index mapped to a plurality of subcarriers in a first OFDM symbol of a first spatial stream, a second pilot sequence having a second index, subsequent to the first index, mapped to a plurality of subcarriers in a first OFDM symbol of a second spatial stream, a repetition of the second pilot sequence with sign inversion mapped to a plurality of subcarriers in a second OFDM symbol of the first spatial stream, and a repetition of the first pilot sequence mapped to a plurality of subcarriers in a second OFDM symbol of the second spatial stream.

18. The apparatus of claim 17, wherein the pilot mapping scheme comprises a third pilot sequence having a third index, subsequent to the second index, mapped to a plurality of subcarriers in a third OFDM symbol of the first spatial stream, a fourth pilot sequence having a fourth index, subsequent to the third index, mapped to a plurality of subcarriers in a third OFDM symbol of the second spatial stream, a repetition of the fourth pilot sequence with sign inversion mapped to a plurality of subcarriers in a fourth OFDM symbol of the first spatial stream, and a repetition of the third pilot sequence mapped to a plurality of subcarriers in a fourth OFDM symbol of the second spatial stream.

19. The apparatus of claim 17, wherein each of the first and second pilot sequences comprises sixteen pilot subcarriers.

20. The apparatus of claim 17, wherein the MIMO transmission comprises a 2×N MIMO transmission comprising two spatial transmit streams.

21. The apparatus of claim 17 configured to cause the wireless station to receive the MIMO transmission over a Directional Multi-Gigabit (DMG) band.

22. The apparatus of claim 17 comprising one or more antennas, a memory, and a processor.

23. A product comprising one or more tangible computer-readable non-transitory storage media comprising computer-executable instructions operable to, when executed by at least one computer processor, enable the at least one computer processor to implement operations at a wireless station, the operations comprising:
receiving a Multi-In-Multi-Out (MIMO) transmission comprising a plurality of spatial streams; and
processing the MIMO transmission according to a diversity scheme comprising a plurality of data symbols mapped to Orthogonal Frequency-Division Multiplexing (OFDM) symbols in the plurality of spatial streams, and a plurality of pilot sequences mapped to the OFDM symbols according to a pilot mapping scheme, the pilot mapping scheme comprising a first pilot sequence having a first index mapped to a plurality of subcarriers in a first OFDM symbol of a first spatial stream, a second pilot sequence having a second index, subsequent to the first index, mapped to a plurality of subcarriers in a first OFDM symbol of a second spatial stream, a repetition of the second pilot sequence with sign inversion mapped to a plurality of subcarriers in a second OFDM symbol of the first spatial stream, and a repetition of the first pilot sequence mapped to a plurality of subcarriers in a second OFDM symbol of the second spatial stream.

24. The product of claim 23, wherein the pilot mapping scheme comprises a third pilot sequence having a third index, subsequent to the second index, mapped to a plurality of subcarriers in a third OFDM symbol of the first spatial stream, a fourth pilot sequence having a fourth index, subsequent to the third index, mapped to a plurality of subcarriers in a third OFDM symbol of the second spatial stream, a repetition of the fourth pilot sequence with sign inversion mapped to a plurality of subcarriers in a fourth OFDM symbol of the first spatial stream, and a repetition of the third pilot sequence mapped to a plurality of subcarriers in a fourth OFDM symbol of the second spatial stream.

25. The product of claim 23, wherein each of the first and second pilot sequences comprises sixteen pilot subcarriers.
